(19) United States
(12) Patent Application Publication
(10) Pub. No.: US 2025/0189690 A1
(43) Pub. Date: Jun. 12, 2025

(54) USING TRUST MODEL TO COMPUTE DYNAMIC RISK AND IMPACT MAPS

(71) Applicant: Halliburton Energy Services, Inc., Houston, TX (US)

(72) Inventors: Bibek Kabi, Bangalore (IN); Julien Christian Marck, Houston, TX (US); Olivier Roger Germain, Houston, TX (US)

(21) Appl. No.: 18/532,933

(22) Filed: Dec. 7, 2023

(51) Int. Cl. E21B 44/00; G08B 21/18

(52) U.S. Cl. CPC G01V 1/50; E21B 44/00; G06T 17/05; G08B 21/182; E21B 2200/20

(57) ABSTRACT

Integrated dynamic impact or risk maps can be generated using borehole operation parameters, with associated impact parameters (representing a severity of an event), softness parameters (representing a range or a percentage of the impact while not exceeding a critical threshold or an impact transition mechanism), and trust parameters (representing the accuracy of the applied advisor model). As borehole operations are in progress, factors change over time, such as depth, temperature, fluid composition, number of rotations, and other operational and environmental factors. As these factors change, the associated impact, softness, and trust parameters can be dynamically updated with the current information. The resulting generation of dynamic impact or risk maps using this information is therefore updated to represent the most current conditions. The dynamic impact or risk maps can be utilized to determine modifications to borehole operations to reduce risk, costs, maintenance downtime, and improve return on investment of the borehole.

### TECHNICAL FIELD

This application is directed, in general, to developing a drilling plan for drilling through a subterranean formation and, more specifically, to determining one or more recommendations for the drilling plan.

### BACKGROUND

In developing a borehole, such as for hydrocarbon production, scientific purposes, or other purposes, it can be important to know the relative risks for executing a drilling operation plan. Risks can impact various aspects of the drilling operation, such as the drilling assembly, the bit life, or the integrity of the drilling system. There can be impacts on the legal contract and liabilities therein (violation of legal contract requires management of change). There can be impacts on the performance, time, or cost of the drilling operation. There can be subterranean formation impacts, such as knowing the rock characteristics, identifying the relative location of nearby water or hydrocarbon reservoirs, knowing where the stratigraphic layers are, and other subterranean formation characteristics. There can be other impacts, such as on the rig and its equipment and systems. Within the oil and gas sector, many industry players have developed different digital advisors that provide recommendations in real-time as well as workflows and best practices to mitigate different risks. It would be beneficial to understand how the various risks dynamically impact drilling operations and what recommendations can be derived in real-time to direct future drilling operations.

### BRIEF DESCRIPTION

Reference is now made to the following descriptions taken in conjunction with the accompanying drawings, in which:

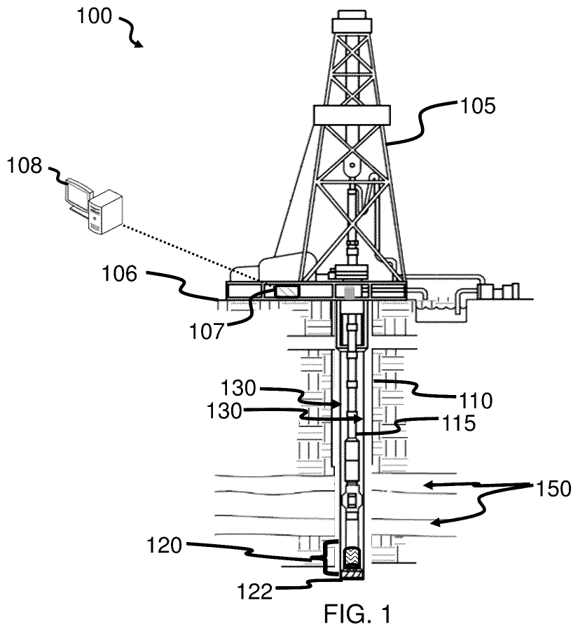

FIG. 1 is an illustration of a diagram of an example drilling system;

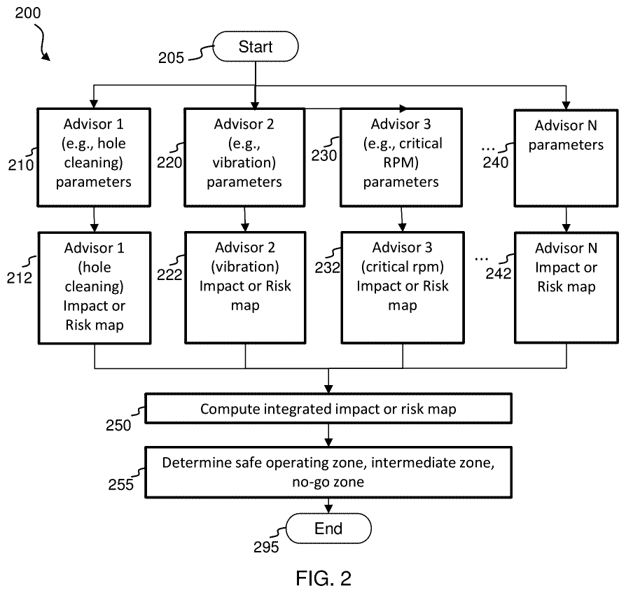

FIG. 2 is an illustration of a flow diagram of an example method for determining the various operating zones;

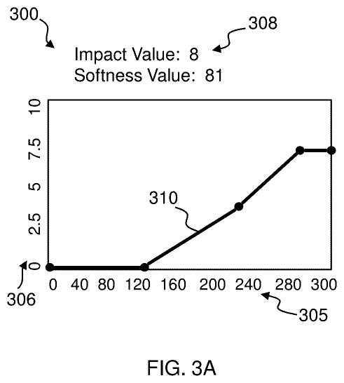

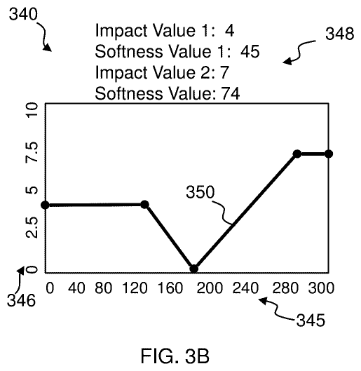

FIG. 3A is an illustration of a diagram of an example graph demonstrating a maximum rotations per minute (RPM) impact map for a first drilling system or a digital advisor;

FIG. 3B is an illustration of a diagram of an example graph demonstrating a recommended RPM impact map;

FIG. 3C is an illustration of a diagram of an example graph demonstrating a minimum RPM impact map;

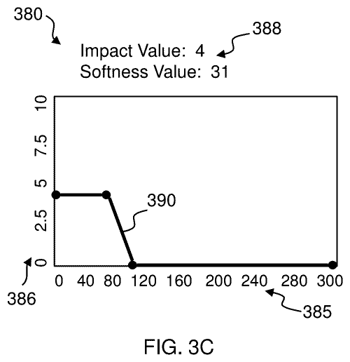

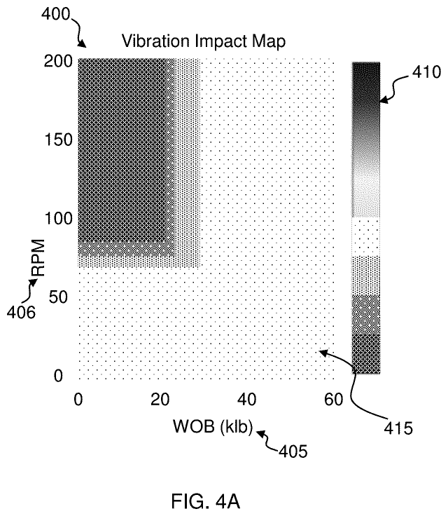

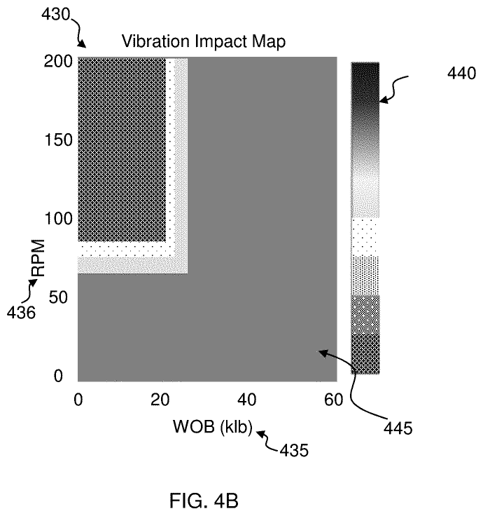

FIG. 4A is an illustration of a diagram of an example graph demonstrating a medium level stick/slip vibration impact map;

FIG. 4B is an illustration of a diagram of an example graph demonstrating a medium level stick/slip vibration impact map when a duration threshold has been exceeded;

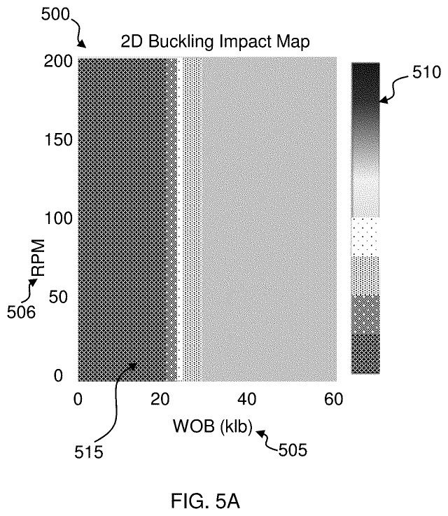

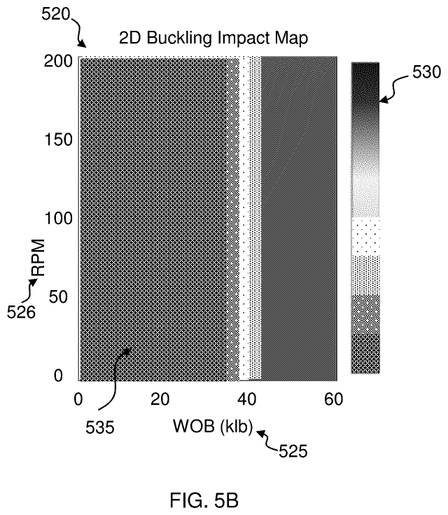

FIG. 5A is an illustration of a diagram of an example graph demonstrating a buckling impact map with the weight-on-bit (WOB) threshold set to 22.0 kilo pounds (klb) for sinusoidal and 28 klb for helical;

FIG. 5B is an illustration of a diagram of an example graph demonstrating a buckling impact map with the WOB threshold set to 36.7 klb for sinusoidal and 39.2 klb for helical;

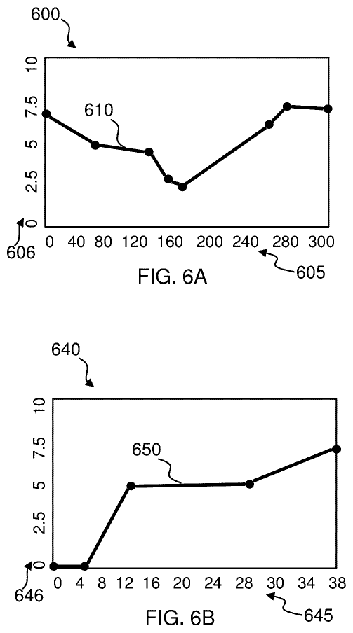

FIG. 6A is an illustration of a diagram of an example graph demonstrating an integrated impact map for RPM;

FIG. 6B is an illustration of a diagram of an example graph demonstrating an integrated impact map for WOB;

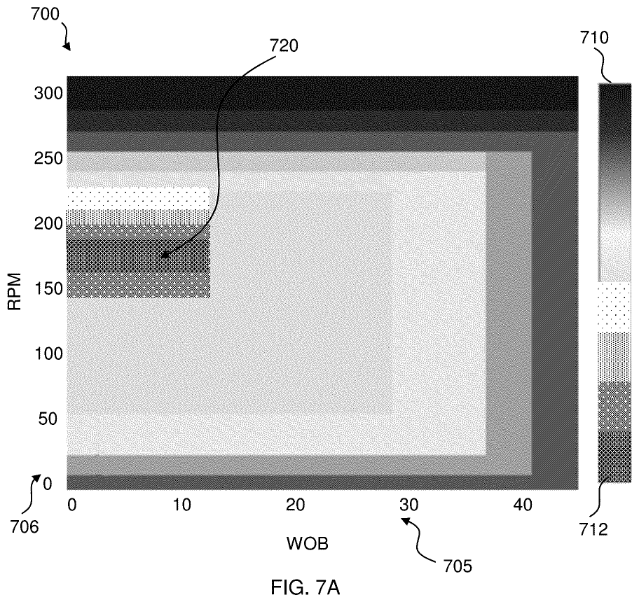

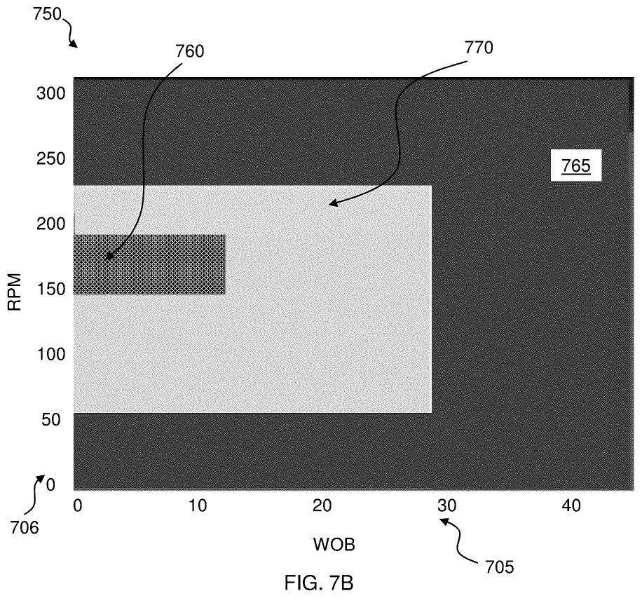

FIG. 7A is an illustration of a diagram of an example graph demonstrating an integrated impact map combining the impact maps of drilling parameters;

FIG. 7B is an illustration of a diagram of an example graph demonstrating a simplified integrated impact map;

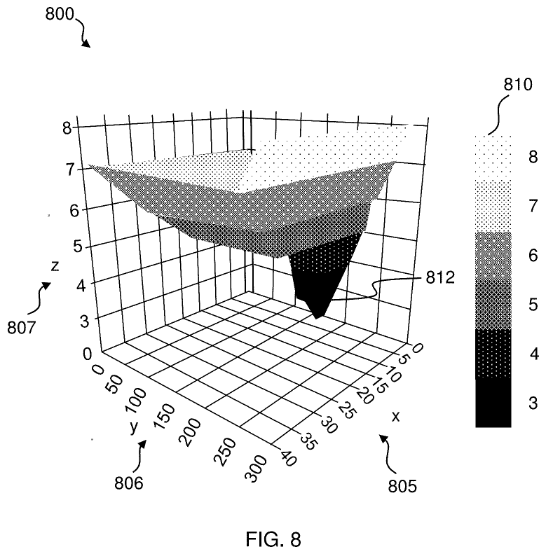

FIG. 8 is an illustration of a diagram of an example graph demonstrating a three-dimensional surface plot for the integrated impact map;

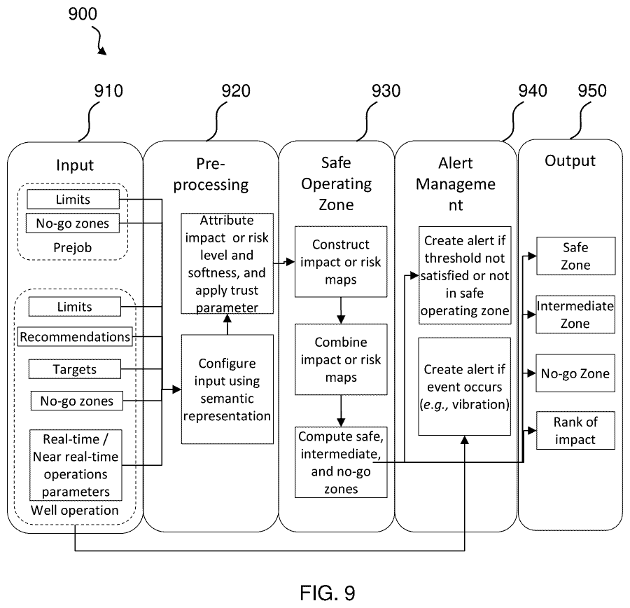

FIG. 9 is an illustration of a diagram of an example block flow demonstrating a process flow as described herein;

FIG. 10 is an illustration of a block diagram of an example orchestration framework system;

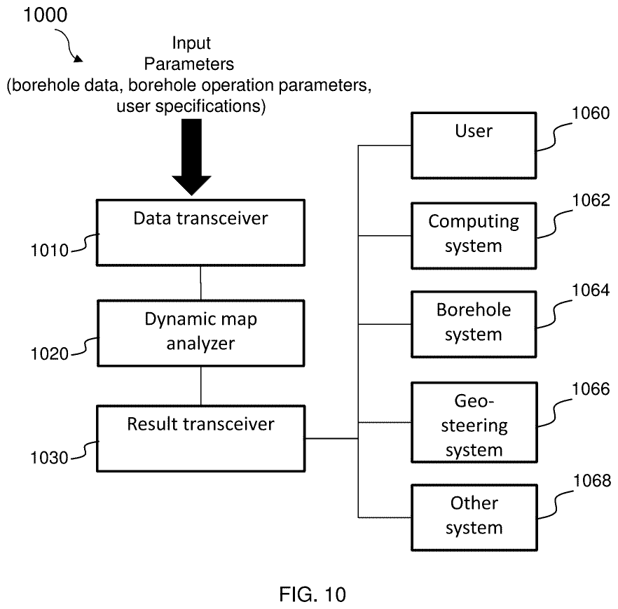

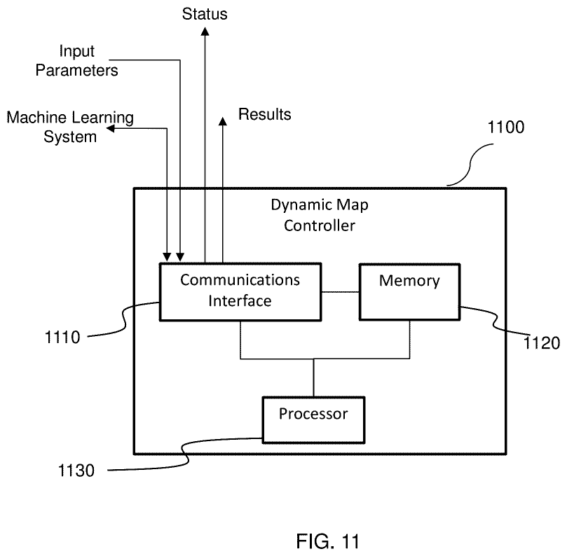

FIG. 11 is an illustration of a block diagram of an example of a dynamic map controller according to the principles of the disclosure;

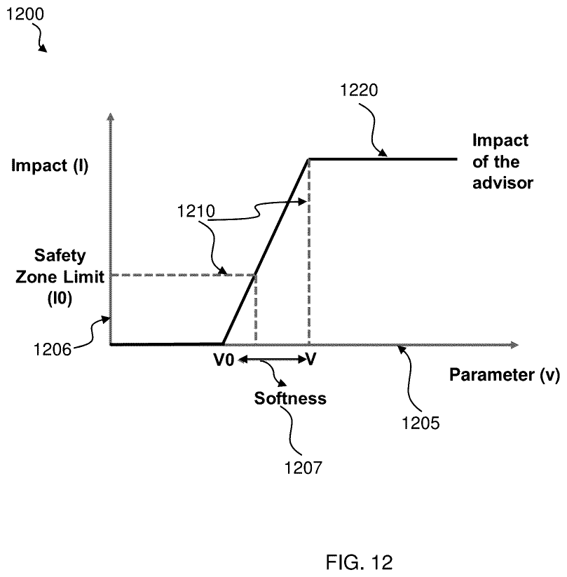

FIG. 12 is an illustration of a diagram of an example chart showing the impact to an advisor using a trust model;

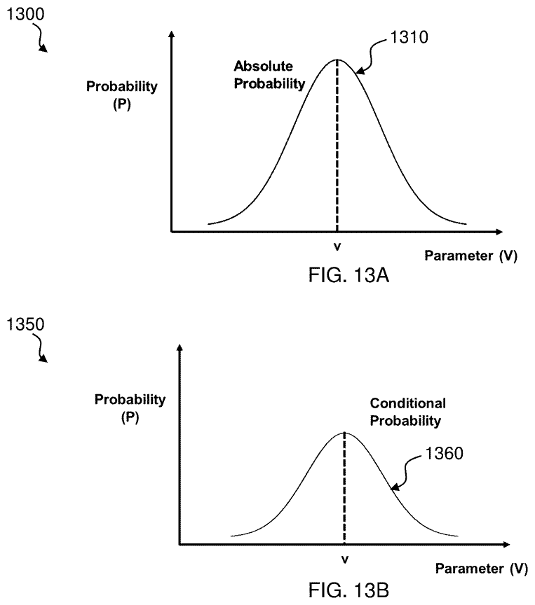

FIG. 13A is an illustration of a diagram of an example chart showing the probability curve before applying a trust model;

FIG. 13B is an illustration of a diagram of an example chart showing the probability curve after applying a trust model;

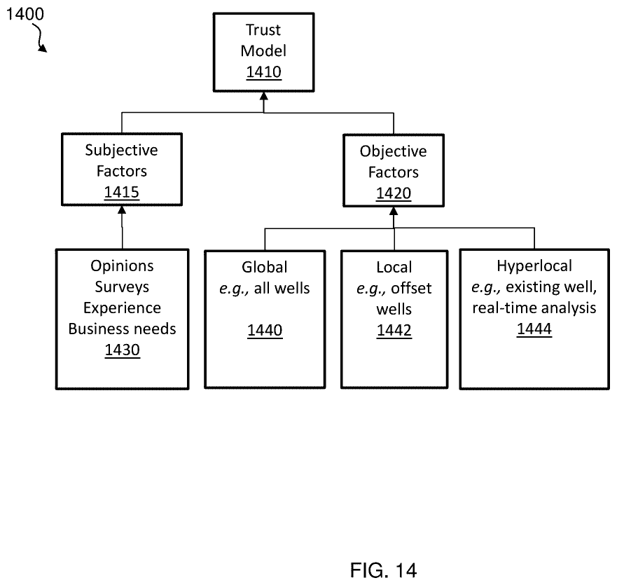

FIG. 14 is an illustration of a block diagram of an example trust model diagram with factors; and

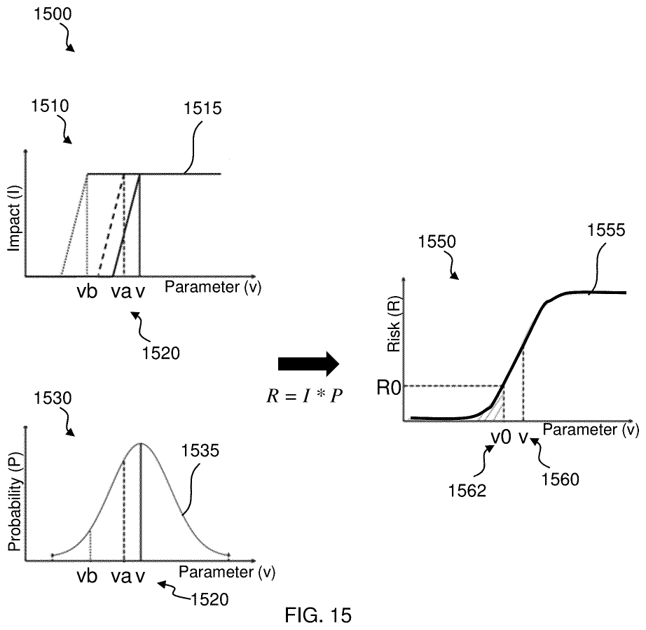

FIG. 15 is an illustration of a diagram of an example risk map incorporating a trust model.

### DETAILED DESCRIPTION

In addition to hydrocarbon production, boreholes can also be used in other areas including geothermal, mining, and scientific research. Users, such as well operators or engineers, can use directional-drilling and geo-steering techniques to maintain borehole development, e.g., drilling operations, along an intended path and direction. Knowing the present position of the borehole and to project the future path of the borehole relative to a location of nearby subterranean formations, proximate boreholes, and objects can be beneficial to ensure borehole distancing, separation, or borehole interception at the desired location. Hydraulic fracturing is another technique that can be used in developing a borehole. One benefit, for example, can be maximizing the potential hydrocarbon production from a subterranean formation reservoir.

Accordingly, the industry has been working towards improving drilling efficiencies, offset-well learning, and automated detection and interpretation of drilling events and dysfunctions. Challenges have arisen, however, in the development of these improvements. Examples of three different challenges are provided below.
(1) Different teams, internal business unit (IBUs), entities, or companies have developed differing solutions that target similar or complementary problems, and the differing solutions may not be compatible or combinable. These solutions can rely on different methodologies (e.g., data based, physics based, or hybrid) and can have different technology readiness levels.
(2) Some solutions can have conflicting objectives that need to be harmonized to provide a consistent set of actions and advisory parameters for automating operations. One example is a rate of penetration (ROP), this is typically desired to be maximized from a drilling point of view while not exceeding a technical threshold from a hole cleaning point of view. Additionally, borehole operation parameter targets or limits from directional, mechanical, or hydraulic objectives can conflict as they seek to optimize different aspects of the operational process.

For example, a vibration advisor can recommend mitigation actions to alleviate different vibration mechanisms. The vibration advisor can recommend increasing the rotations per minute (RPM) and reducing the weight-on-bit (WOB), if a stick/slip vibration occurs. From a hole cleaning and pressure management standpoint it may not be advisable to increase the RPM because increasing the RPM might exceed the equivalent circulating density (ECD) limit and not achieve the target ROP. Another example can occur with a bit bounce or whirl vibration situation. The vibration advisor can recommend decreasing the RPM to mitigate the vibration, whereas from a hole cleaning point of view the RPM must be increased to at least achieve the target ROP under current average conditions. During such conflicting scenarios it can be difficult for a user or a borehole system to determine the best recommendation from a drilling efficiency standpoint.
(3) There may not be a cohesive orchestration framework that encompasses the above challenges and the other factors that go into the well (i.e., borehole) operation decision process. For non-conflicting solutions, a rule-based logic or decision tree-based framework can be implemented. For example, a rule can be implanted for removing critical RPM from a vibration point of view from the cleaning targets. The challenge with such a rule-based approach can be that it is not scalable to orchestrate multiple solutions with conflicting recommendations in real-time or near real-time.

It would be beneficial to develop an efficient orchestration framework that can coordinate multiple recommendations from different systems and be able to scale up to accommodate as many factors, systems, or digital advisors as available. The framework can be highly versatile and flexible to allow a user to integrate other systems or digital advisors. This type of orchestration framework can improve the decision making and operational efficiency of drilling operations of a borehole. The risks and consequences used to develop the orchestration framework are not usually constant (they can be dynamic), as external effects or the context of the active borehole operation may not be captured when the pre-job assumptions are determined or be captured by the assumptions of the independent advisors. The pre-job assumptions or assumptions of the independent advisors are used to develop the borehole operation plan, and so as those assumptions change, the borehole operation plan may need to change as well, depending on the factors being modified.

The orchestration framework can utilize one or more recommendations. Currently, a challenge is to assess the quality of each recommendation or the accuracy of the advisors. The quality or accuracy can be less than optimal due to a variety of reasons, for example, model assumptions, third party black boxes, nested safety factors, unknown transitions between safe and unsafe, or other reasons. This challenge can result in an overapproximating or an underapproximating of the impact severity level, which can influence the dynamic risk maps. Therefore, it can be significant to know the accuracy of the advisors and veracity of the consequences on the drilling system for which these digital advisors have been developed.

This disclosure presents processes to provide an orchestration framework that can generate one or more recommendations to direct borehole operations to maintain those operations within a safe operating zone or to move the operation toward operating in the safe operating zone for the specified operations parameters by coordinating multiple recommendations from various systems in real-time or near real-time. In some aspects, the one or more recommendations can reinforce positive results by directing borehole operations to improve efficiency or reduce cost, even though the borehole operation may be operating within a safe operating zone. In some aspects, the one or more borehole recommendations can be used to execute a borehole operation plan or to modify a borehole operation plan for the borehole. In some aspects, the one or more borehole recommendations can be used in an advisory mode.

In some aspects, the one or more borehole recommendations can be used in a post-job mode, where an impact is made on learnings and future borehole operations, while the current borehole operation is not impacted. The borehole operation plan can include steps for performing one or more borehole jobs, for example, a drilling operation, a logging operation, a completion operation, a production operations or other types of borehole operations, including directing equipment, devices, or sensors to perform these borehole operations. The borehole operation plan can include one or more borehole operations.

Real-time or near real-time is a level of responsiveness by a borehole system or a user as sufficiently immediate or that enables a processor to keep up with processing of inputs. In some aspects, the input data can be processed within milliseconds so that it is available very quickly as feedback. In some aspects, the input data can be processed in a sufficient time frame as to be made available to a user, other systems, or processes before a next scheduled time interval. For example, a time interval can be in seconds, minutes, hours, or another time interval. In some aspects, the processes can be performed during a time interval of 5 minutes, 20 minutes, 1 hour, or other smaller or larger time intervals. As new information is received, such as from downhole sensors, or new suggestions are received from digital advisors, the processes or process can be performed again to determine a new set of recommendations.

Borehole operations can be improved through advantageous monitoring of events and monitoring the digital advisor's behavior in various situations, and then generating impact or risk maps that can capture these nuances progressively or incrementally. The impact parameters (e.g., impact values or risk values) can represent a positive impact or negative impact to the borehole operation being monitored. Generally, each advisor can recommend one impact value parameter and one softness value parameter, along with a trust parameter of the model used by the advisor, for each type of recommendation. For example, an advisor can generate a recommendation for a current operation bounding and a second recommendation for an optimized bounding. Positive impacts can be used to improve optimization of the borehole operation in scenarios where the safe operating zone is not being impacted. Negative impacts can be used to improve borehole operations that could impact the safe operating zone. In some aspects, either the positive or negative impacts can dynamically change the risk (e.g., the risk can increase or decrease) which can result in dynamic impact maps or dynamic risk maps being generated.

There can be two sources of uncertainty while constructing the dynamic risk maps. The first can be determined while developing an advisor's model where there can be one or more unknown parameters or known uncertainty to a measurement. There can be an underlying probability distribution for the recommendation of the advisor, assuming that the model is correct. The second type of uncertainty can be the trust parameter derived from a trust model of the advisor. The probability distribution of the recommendation can be modified by the trust parameter computed from different sub-components which, when combined with impact map, can improve the efficiency of computing the dynamic risk maps.

In some aspects, in addition to using impact value parameters and softness value parameters, the advisor can utilize a trust parameter derived from the trust model. The trust model can enable the evaluation of how likely the recommendation of the advisor represents the true state of the borehole operation. The trust parameter can be used, for example, as a factor in prioritizing the recommendations of the advisors to improve the efficiency of computing the safe operating zone.

The trust model can be built using a multi-disciplinary approach. The trust model utilizes subjective factors and objective factors. The subjective factors can describe an expectation of the behavior by other entities, for example, using opinions, surveys, experience, business needs, or other user inputs. For example, one or more users (such as technicians, engineers, testing lab workers, experts, or other people with appropriate knowledge) can contribute a weighting parameter to the trust model. The weighting parameter can quantify the accuracy of the advisor by using the user's subjective knowledge in combination with an observation of the advisor. The objective factors can utilize characteristics such as a stochasticity characteristic, a measurability characteristic, a context-dependent characteristic, or an incomplete transitivity characteristic.

Stochasticity defines the uncertainties in incorporating the unknowns within the advisor's algorithm. In some aspects, the stochasticity parameter can be represented using a probability model, a probability bell curve, a standard deviation, or types of probability representations. Measurability defines the trustworthiness of the objective measure used by the advisor. In some aspects, the measurability can be a binary selection, for example, the value being used is measurable or not measurable. In some aspects, the measurability can be a probability parameter that the value is an accurate measure, for example, the measurability parameter can be x % confident that the value or range of values is an accurate measure of the parameter trying to be measured, such as being 95% confident that the current fluid pressure at the drill bit is of a reported value.

Context-dependent defines the context in which the measure parameter was collected. In some aspects, the context-dependent factor can utilize the physical environment in which the measurement was collected. For example, a measure can be taken by a tool within different types of subterranean formations, e.g., sedimentary layers, water layers, oil layers, specific types of rocks, at certain depths where the depth can influence the measure, such as fluid pressure or heat, at surface or near surface locations, or other physical environments. In some aspects, the context-dependent factor can utilize the types of tools being used. For example, a nuclear magnetic resonance sensor can have a different context-dependent factor than an acoustic sensor, especially at different depths. In other examples, certain tools, even if not directly used in collecting the measurements, can influence the measurements, for example, different drill bit types can produce a different ambient heat signature that needs to be taken into account when heat is being measured by another sensor.

Incomplete transitivity defines a factor that can be used to compare an advisor across differing scenarios or situations. In some aspects, each type of borehole operation can have its own trust parameter. For example, using the same equipment at the same depth in the borehole measuring the same advisor parameter can have different transitivity parameters during different borehole operations, such as active drilling and paused drilling when logging, or pumping a fluid downhole and pumping a fluid with a different composition downhole.

The objective part of the trust model can be computed by receiving or collecting data from one or more sources where the data was collected in scenarios or situations that are similar to the current scenario or situation. For example, data can be collected from an offset well and used as input data to the objective part of the trust model. In some aspects, the data can be received directly from the wells, lab analysis, or other locations where the data is collected. In some aspects, the data can be received from data storage locations, for example, a data center, a cloud environment, a server, an edge system, or other data storage systems. In some aspects, the objective part data can be received from a machine learning system. For example, the machine learning system can quantify the accuracy of the advisor recommendations using data collected from other sites, reservoirs, boreholes, or well sites. The quantification can utilize offset well analysis or real-time analysis under different contexts.

This quantification of the accuracy for the objective part of the trust model can be represented by computing and combining global parameters, local parameters, and hyperlocal parameters. The global parameters can be derived from available wells or boreholes, regardless of the location of the wells or boreholes. The local parameters can be obtained from off-set well analysis of the current borehole. In some aspects, the hyperlocal parameters can be obtained through real-time or near real-time monitoring and analysis of the current borehole. In some aspects, the hyperlocal parameters can be obtained by evaluating the consequences of critical events with the global parameters analyzed using different contexts.

The addition of the trust model to the impact and softness analysis can improve the business analysis and application of the advisors, and improve recommendations to each borehole operation. This can lower costs, improve efficiency, improve safety, or reduce wear and tear on equipment, by guiding through advisor recommendations, the operational parameters of borehole equipment to maintain the operational parameters within the safe operating zone or to bring the operation back toward the safe operating zone. For example, the advisor recommendations can involve changes to borehole fluids, such as the flow rate, pressure, or composition. The advisor recommendations can involve changes to a drilling assembly, such as a bottom hole assembly or drill bit. The advisor recommendations can involve the use of sensors, such as a time or place to collect data.

In some aspects, the advisor recommendations can guide an adjustment to a fluid flow rate, a fluid composition, or a fluid pressure, such as a drilling fluid, a drilling mud, a hydraulic fracturing fluid, an injection fluid, or other types of fluid. The fluid flow rate, fluid pressure, or fluid composition can be measured at a surface location, within a delivery pipe leading downhole, or at downhole equipment, such as valves, drilling assemblies, or other equipment. For example, the advisor recommendation can recommend that fluid pressure be lowered when the fluid is pumped from a surface pump, or that a additives be added to or removed from the fluid before it is pumped downhole. In some aspects, the advisor recommendations can guide an adjustment to a drilling bit assembly or bottom hole assembly. For example, the advisor can recommend an adjustment to the drilling angle to bring the drilling path back toward an optimal path, or the advisor can adjust the rotations per minute of the drill bit or the weight-on-bit exerted on the drill bit. In other examples, the drill bit wear parameter can be updated using the output of the advisor recommendation, the rate of penetration or a maximum rate of penetration of the drill bit can be updated using the advisor recommendation.

In some aspects, the advisor recommendations can guide the use of when sensors are employed and data collected. For example, the advisor can recommend a time interval for drilling operations to pause while sensors collect data downhole. In some aspects, the advisor recommendations can guide operations as to when equipment needs to be changed. For example, the advisor can recommend that specified sections of casing be replaced, or that a pump or drill pipe segment is approaching the end of its respective operational life. This aspect can advise on replacing equipment or portions of equipment prior to a failure occurring which could result in higher costs to resolve. In some aspects, the advisor recommendations can guide operations as to when hole cleaning operations should be conducted or to estimate a stuck drill string situation and recommending a maximum amount of force needed to release the drilling assembly. In some aspects, the advisor recommendations can be used to direct operations of sensors, such as to upgrade or downgrade sensors to meet the theoretical requirements of the recommended model.

These advisor recommendations can result in various types of overall benefits to the operations at the borehole or reservoir. In some aspects, the disclosure can improve the coordination among different IBUs thereby increasing the efficiency by integrating multiple recommendations produced by the applications of different IBUs and by producing a composite advice by producing the dynamic risk maps. These risk maps can become more efficient and can capture the changing nuances on the system by evaluating the trust of the recommendation of the advisors. In some aspects, the architecture of the orchestration framework can be versatile, which makes it easier for integrating customer's applications into the framework. This can increase the service value to customers.

In some aspects, a user-friendly platform can be developed to realize the disclosure. Different IBUs and the customers can use the platform to smoothly integrate their applications for orchestration. In some aspects, the user-friendly platform can leverage recommendations, impact, softness, and trust parameters in various forms, such as being static parameters, or represented as a road map. The software scalability feature of the platform can allow customers to use and integrate their recommendations for producing a composite advice in real-time or near real-time.

In some aspects, the disclosure can act as a tool for evaluating efficiency of drilling operations. The processes can save a measurable amount of time on operations (such as drilling) by reducing the amount of time an operator or other type of user uses to investigate or rationalize data across multiple independent advisors prior to making a decision.

In some aspects, the ability to compute dynamic risk maps with the trust model in real-time or near real-time can be one step towards building a complete dynamic solution for orchestration. The composite advice (e.g., the safe operating zone) produced by the framework can act as a standard for drilling or operating contractors. In some aspects, the ability to compute dynamic risk maps using the trust parameter in real-time or near real-time can add value and capacity to existing scalable frameworks where they can leverage recommendations in various forms. The scope of the framework can be increased to allow customers to smoothly integrate their dynamic inputs in real-time or near real-time.

In existing frameworks, a composite advice (e.g., a borehole operation modification resulting from an analysis of one or more impact or risk maps) was produced when the process received recommendations from the digital advisors. However, there can exist dysfunctions and events that directly influence the impact and softness values attached to a digital advisor. These values can change dynamically depending on various factors, thereby generating dynamic impact maps or dynamic risk maps. One of the challenges that this disclosure addresses is the ability for the existing framework to compute dynamic impact maps or dynamic risk maps in real-time by supervising events and digital advisor's behaviors based on different contextual criteria.

Dynamic impact or risk maps can be generated using one or more types of algorithms, such as rule-based or learning-based. Under these mechanisms, several rules or criteria can be defined, such as cumulative occurrences, cumulative duration, determined flags, determined conditions, determined events, or roadmap inputs. Depending on thresholds for the cumulative occurrence or duration of a determined event, the impact value and the softness value can be changed, thereby dynamically adapting the impact or risk maps to the larger borehole operation context (e.g., modifying the drilling operation plan, or executing a drilling operation plan using the results to modify the operation steps, such as changing the ROP, the RPM, the drilling fluid flow rate, or other factors). For example, stick/slip vibrations can have a long-term impact on the system and mitigation protocols become more relevant as the tool closes on its specified mechanical limits.

A dynamic impact or risk map can thus be created to capture the dynamic risk to the system and the related safe operating zone. The criteria can also be of a conditional nature: if certain conditions are met, the impact level and softness value can change (e.g., being overridden) irrespective of the type of recommendation provided by the advisors. For example, supervising ROP for hole cleaning issues can trigger a switch toward a more optimal flow rate-RPM combination if a recommended ROP threshold is crossed. A dynamic impact or risk map can also be an output from a machine-learning algorithm, or a register or roadmap developed from offset-well analysis and lessons learned from previous experiences (e.g., previous wells). For example, depth-based or time-based roadmaps can be used to refine the impact values and softness values used to develop the dynamic impact or risk maps.

In some aspects, a register can be a database of impact maps or risk maps, and actions. Actions can be a correlation of the impact parameters and softness parameters, with the limits or recommendations. In some aspects, a register can be archived based on contexts. For example, the impact maps can be associated with a given context. As another example, a register can be a depth or time-based roadmap for tracking the impact parameters, the softness parameters, and the resulting limits or recommendations.

In some aspects, a scalable orchestration algorithm or logic can be implemented utilizing dynamic operational impact assessments for borehole operations. In some aspects, a scalable algorithm can be implemented to compute dynamic impact or risk maps by supervising the duration and frequency of occurrence of a high impact event. In some aspects, a scalable algorithm can be implemented to compute dynamic impact or risk maps when certain conditions are met. In some aspects, a scalable algorithm can be implemented to compute dynamic impact or risk maps utilizing experience or learning gathered from previous well and offset well analysis. For example, a depth-based roadmap can utilize impact and softness values for different vibration mechanisms developed from an offset well analysis.

In some aspects, an impact or risk map register can be implemented to archive actions and impact or risk maps from previous borehole operations from the current or other borehole systems. In some aspects, a process can be implemented to take into consideration recommendations or limits for impact values or softness values utilizing a roadmap for different borehole operation parameters. In some aspects, a process can be implemented to alert a user, a user system, or a borehole system about the change in the recommendation or limit for impact values or softness values specified according to the roadmap. In some aspects, a process can be implemented to consume roadmap-based input provided as a function of time or depth.

In some aspects, it could take a time interval, such as more than one minute, for data to be transmitted from a downhole location to a surface computing system, therefore the time interval delay in receiving the data can be considered real-time or near real-time performance. In some aspects, the processes can be performed within a time interval so the results are ready for a subsequent analysis, such as every five minutes, every twenty minutes, or another specified time interval.

Well construction operations (e.g., can be part of borehole operations) can encompass various drilling activities, for example, drilling operations, active drilling within the borehole, tripping in or out, back reaming, casing placement, cementing, or other operations conducted within the borehole. The remaining descriptions utilize drilling operations to demonstrate and describe the disclosed processes, while the disclosed processes can apply to the various well construction operations. The parameters used by the processes can be related to one or more of the drilling operation activities. For example, the parameters used can be controlled directly by the drilling operation, such as WOB, RPM, or flow rate, be an output of the drilling operation, such as ROP, ECD, differential pressure, or torque, or be related to off-bottom operations or phases.

In some aspects, the process can generate alarms, alerts, and notifications in real-time or near real-time. In some aspects, the orchestration framework can provide a validation across systems, vendors, or other processes using a scalable orchestration logic. The process can utilize an orchestration framework utilizing impact maps.

An impact or risk map can be a representation of a relationship of an impact or risk severity level (on a relative or absolute scale, e.g., from 1 to 10, or other ranges) and borehole operation parameters, for example, RPM, WOB, flow rate, ROP, and other conventional borehole operation parameters. The impact or risk map can be a one, two, three, or higher dimensional relationship. In some aspects, the impact or risk map representation can be a mathematical representation, a graphical representation or a data relationship (such as stored in a database, data file, or other type of data relationship) stored on a computing system, file system, or other computing storage system. In some aspects, the impact or risk map representation can be graphical or other visual representation of the data. In at least one aspect disclosed herein, a risk map is equivalent to the product (integral product) of an impact map and the probability density function around the recommended drilling parameter. Therefore, a risk map can be equivalent to the impact map when the probability parameter is equal to one, e.g., the process is deterministic.

The impact severity levels can be determined prior to the start of a drilling operation (e.g., pre-job), such as by using literature surveys, information from subject matter experts, prior experiments in a lab, data and learnings from prior well construction operations at the current borehole or another borehole, industry data, or other data sources. They can be updated in real-time or near real-time depending on the set of circumstances. For example, a low level of stick/slip that lasts for a few seconds can have a low impact on the system, while a severe stick/slip event lasting more than 30 minutes (this threshold is used as an example, the actual time threshold can vary on the specific downhole circumstances and the tool specifications) can have a significant impact on the integrity of the system, e.g., the tool is outside limit, and need to be mitigated as soon as possible. In a similar manner, it can be important to know the relative level of risk involved if there is a hole cleaning issue, if the ECD limit is exceeded, or if a steering objectives are not met. The risk level can encapsulate the probability parameter and the impact (in terms of time, cost, or both) of an identified limit or dysfunction.

During the well construction operation, depending on the recommended limits produced by the independent digital advisors, the impact and risk maps can be generated in real-time or near real-time for each of the well construction parameters. The idea of limits can be extended to include “no-go” or “go” zones, relative or syntactic recommendations (e.g., increase or decrease), limits, and specific targets or set points. Once the individual impact or risk maps are generated for each well construction parameter, an integrated impact or risk map (i.e., a combined impact or risk map) can be computed using the individual impact or risk maps. Various algorithms can be used to perform the integration, for example, taking the maximum values to generate a maximum impact or risk map. The integrated impact or risk map can be further used to determine the safe operating zone for the well construction parameters. Within this zone, the impact level would typically be low or acceptable, and the critical impacts can be clearly identified.

In some aspects, the processes can include a scalable orchestration logic utilizing an impact assessment. In some aspects, the processes can include a computational method to combine the impact or risk maps. In some aspects, the processes can include facilitating automated decision-making ability thereby increasing operational efficiency, such as providing the combined impact or risk maps to a decision-making system where the combined impact or risk maps can be used to determine a course of action. In some aspects, the processes can include an ability to recommend a safe operating zone to users or a drilling system in real-time or near real-time.

In some aspects, an ability to provide the user with the discretion to select one or more well construction parameters or impact parameters to be used in the analysis and recommendation generation. There can be situations where a sub-set of well construction operations can be used for a well construction operation. In some aspects, a smart alert management system can be used to communicate an alert to a user or a system (such as a well site controller, a rig controller, borehole assembly, or other borehole system) in real-time or near real-time using various types of alert systems. For example, an alert threshold can be exceeded when the current drilling parameters received from downhole and surface sensors indicate that the drilling assembly is not in a safe operating zone. In another example, an alert threshold can be exceeded when the one or more recommendations result in an impact severity greater than an alert threshold parameter. In some aspects, a user-friendly platform can be built for the orchestration framework.

The impact or risk maps of the digital advisors may not always be fixed or consistent. They can change depending on various factors. This disclosure describes two mechanisms (a rule-based and a learning-based mechanism) comprising of several criteria under which dynamic impact or risk maps can be generated in real-time or near real-time. The rule-based mechanism can implement an algorithm or a decision tree on top of the scalable framework utilizing different criteria, for example, frequency of occurrence, duration of an event, or non-anticipated conditions. Similarly, the learning-based mechanism can implement roadmap-based recommendations where the impact values, the softness values, and the trust parameters use the knowledge or experience gathered from previous stages of the current borehole, other borehole systems, offset well analysis, or a machine learning algorithm.

For example, some rule-based mechanisms are described. For non-anticipated conditions, the cutting concentration can be a factor that is analyzed. Quantitatively, the ROP defines the amount of cuttings generated during operations. The cuttings concentration inside drilling fluid becomes more important when ROP increases which leads to more challenged hole cleaning and hydraulic requirement. The greater ROP, the bigger the cuttings stranded. A proper cutting concentration is the key parameter of controlling wellbore pressure and ECD. As per the models developed for calculating cuttings concentration, it is recommended that the concentration of suspended cuttings should be a value less than an engineering threshold. So, if the cuttings concentration is close to the recommended limit (e.g., an impact (criteria) threshold), then the softness value for the recommended RPM or flowrate can be reduced dynamically allowing less margin to push the current values, thereby limiting the ROP, and henceforth restraining a possible hole cleaning issue. The impact can be increased when the maximum cuttings load is exceeded to capture increasing risk on the system.

Another example uses standpipe pressure. One of the scenarios prevalent in drilling is that the drilling fluid may not be properly transporting the cuttings and caving material out of the annulus. That can lead to pack off or bit balling issue. These can be identified by reduced ROP and increased standpipe pressure that could be close to its limit. During such a scenario, the softness parameter for the recommended RPM or flowrate can be dynamically increased so that there is a significant margin for pushing the envelope or boundary to increase the RPM or flowrate.

Another example can use the curve versus lateral sections of a borehole as a differentiating factor. The most common type of drill pipe failure is fatigue wear. It occurs while drilling high dogleg curve sections where the pipe goes through cyclic bending stresses and high vibrational forces. If the dogleg severity (DLS) value is close to the maximum permissible DLS limit for fatigue damage, the softness value can be reduced or the impact value can go higher dynamically for some advisors to limit the damage to the system. Another use case for curve versus lateral analysis is the steering recommendations for drilling parameters to deliver sufficient or optimal directional control capability. Depending on whether the current section being drilled is straight or curved, the impact or risk map can be adapted accordingly because the impact of falling off the well plan is relatively more detrimental in curved sections compared to lateral sections.

Another example uses the vertical versus lateral or even complicated wells with angle (for example an “S” shaped well) factors. Hole cleaning can be relatively easier in a vertical well compared to lateral or complicated wells with angle since they are more prone to have the cuttings bed formed on the low side which makes cleaning difficult. Hence, the impact or risk maps should be dynamically adapted depending on these contextual factors. For instance, the hole cleaning impact is relatively higher in lateral or in complicated wells with angle compared to vertical section because the hole cleaning recommendations become more significant in those contexts.

In some aspects, (as an example) a hole cleaning impact or risk map can dynamically change as a function of the current depth since it can take longer to clean a hole as the drilling goes deeper in the borehole (where depth is the measured depth or length of the borehole). The cleaning processes can take a longer time to clean a longer hole, and the hole cleaning advisor's recommendation can become more significant as a result. For hole cleaning impacts, monitoring the ROP and the ECD are important from a hole cleaning and pressure management standpoint. If the ECD creeps up to a limit which could lead to the risk of mud invading fracture zones, then permanent formation damage can occur. If the ECD goes too low, cuttings and cavings could accumulate around the bottom hole assembly, which could prevent fluid flow, and sticking of the drill string in the hole. Therefore, ROP is important in controlling ECD. In an aspect where too much rock is drilled too quickly, the suspended cuttings can increase the mud density and hence the ECD. Hence, it is important to react and construct dynamic impact or risk maps by supervising the ROP continuously.

For example, if the instantaneous ROP is less than the average ROP (e.g., recommended by a hole cleaning advisor) that is achievable under current average conditions then the system can have less than optimal performance but with no obvious impact (related to a hole cleaning issue). Under this scenario, if the current drilling RPM or flowrate is higher than the RPM or flowrate recommended by a hole cleaning advisor, the system may not have an obvious or instantaneous impact.

This disclosure can provide benefits in several ways. In some aspects, this disclosure can improve the coordination among different systems or digital advisors, solution providers, or company systems thereby increasing the efficiency by orchestrating multiple recommendations produced by the various processes, and by prioritizing those recommendations that have been generated by advisors using a model with a high trust parameter as compared to those advisors with a lower trust parameter for its model. In some aspects, the architecture of the orchestration framework can be versatile to enable an easier integration into another system or digital advisor, application, or process. This can improve the service value of the disclosed process. In some aspects, a user-friendly platform can be developed to implement the disclosure, such as using micro-services or other types of implementation platforms. In some aspects, the processes can act as an input into a drilling automation system. As a result, the process can save time of the drilling operation or of a user by reducing the amount of individual drilling parameters that are evaluated outside of the disclosed processes.

Other benefits can be realized. In some aspects, the disclosed processes can improve the coordination among different corporate entities or IBUs, thereby increasing efficiency on integrated operations by integrating IBU-specific recommendations produced by their respective advisors. In some aspects, the disclosed processes can implement a versatile architecture of the orchestration framework, which can make it easier for integrating customer's and third party's applications. This can maximize the service value for customers.

In some aspects, the disclosed processes can implement a user-friendly platform to implement the processes. Different IBUs within a company and its customers can use the platform to smoothly integrate their recommendations for orchestration and aligns on workflows for composite decision making. In some aspects, the disclosed processes can leverage recommendations, impact values, softness values, or trust parameters in various forms. These values or parameters can be static or dynamic.

In some aspects, the disclosed processes can act as an efficient tool for drilling automation. As a result, it can improve consistency by automating the decision-making process across multiple independent digital advisors. In some aspects, the disclosed processes can implement the ability to compute dynamic impact or risk maps in real time. Being a complete dynamic solution, the composite advice or safe operating zone produced by the framework can act as a standard for all stakeholders. In some aspects, the disclosed processes can implement the ability to compute dynamic impact or risk maps in real-time or near real-time which can be used to add capacity to the existing scalable framework to leverage recommendations in various forms. In some aspects, the disclosed processes can increase the scope of the framework to allow customers to more efficiently integrate their dynamic inputs in real-time or near real-time. In some aspects, the disclosed processes can generate composite advice that can be communicated to a rig control system for enabling drilling automation (such as fully automated or partially automated decision processing).

Turning now to the figures, FIG. 1 is an illustration of a diagram of an example drilling system 100, for example, a logging while drilling (LWD) system, a measuring while drilling (MWD) system, a seismic while drilling (SWD) system, a telemetry while drilling (TWD) system, injection well system, extraction well system, and other borehole systems. Drilling system 100 includes a derrick 105 that includes a rig controller, a well site controller 107, and a computing system 108. Well site controller 107 includes a processor and a memory and is configured to direct operation of drilling system 100. Derrick 105 is located at a surface 106.

Extending below derrick 105 is a borehole 110 with downhole tools 120 at the end of a drill string 115. Downhole tools 120 can include various downhole tools, such as a formation tester or a bottom hole assembly (BHA) (e.g., a borehole operation assembly). Downhole tools 120 can include a resistivity tool or an ultra-deep resistivity tool. At the bottom of downhole tools 120 is a drilling bit 122. Other components of downhole tools 120 can be present, such as a local power supply (e.g., generators, batteries, or capacitors), telemetry systems, sensors, transceivers, and control systems. Borehole 110 is surrounded by subterranean formation 150.

Well site controller 107 or computing system 108 which can be communicatively coupled to well site controller 107, can be utilized to communicate with downhole tools 120, such as sending and receiving acoustic data, telemetry, data, instructions, subterranean formation measurements, and other information. Computing system 108 can be proximate well site controller 107 or be a distance away, such as in a cloud environment, a data center, a lab, or a corporate office. Computing system 108 can be a laptop, smartphone, PDA, server, desktop computer, cloud computing system, other computing systems, or a combination thereof, that are operable to perform the processes described herein. Well site operators, engineers, and other personnel can send and receive data, instructions, measurements, and other information by various conventional means, now known or later developed, with computing system 108 or well site controller 107. Well site controller 107 or computing system 108 can communicate with downhole tools 120 using conventional means, now known, or later developed, to direct operations of downhole tools 120.

Casing 130 can act as barrier between subterranean formation 150 and the fluids and material internal to borehole 110, as well as drill string 115. An orchestration framework system can be present, such as a dynamic map analyzer (e.g., an impact map processor or an orchestration framework analyzer for determining dynamic impact maps or dynamic risk maps) or an orchestration framework controller (e.g., a dynamic map controller). The orchestration framework can receive input parameters from sensors located downhole, such as part of the downhole tools 120 or part of the BHA. In some aspects, the orchestration framework can generate analysis of the impacts and determine recommendations for directing the drilling operations. In some aspects, the orchestration framework can produce visual graphs enabling a user to see where the safe operating zone is for the given borehole operation parameters and recommendations coming from different digital advisors in real-time. In some aspects, the orchestration framework can consider other data measurements to compute the safe operating zone, such as data measurements from another location within the borehole, proximate boreholes, a surface location, models, survey data, geological data, such as from a data center, database, or cloud environment.

In some aspects, the orchestration framework can communicate the recommendations (for example, the safe operating zone, the no-go zone, or other recommendations) to another system, such as computing system 108, well site controller 107, a rig controller, or other boreholes assembly where the recommendations can be combined with other analysis or used for decision making processes. In some aspects, computing system 108 can be the orchestration framework and can receive some of the input parameters from one or more of the sensors in downhole tools 120. In some aspects, well site controller 107 can be the orchestration framework and can receive some of the input parameters from one or more of the sensors part of downhole tools 120. In some aspects, the orchestration framework can be partially included with well site controller 107 and partially located with computing system 108. In some aspects, well site controller 107 can be the rig controller. In some aspects, the functionality described for well site controller 107 or computing system 108 can be part of another borehole assembly or borehole system.

FIG. 1 depicts onshore operations. Those skilled in the art will understand that this disclosure is equally well suited for use in offshore operations, geothermal operations, or hydraulic fracturing operations. FIG. 1 depicts specific borehole configurations, those skilled in the art will understand that the disclosure is equally well suited for use in boreholes having other orientations including vertical boreholes, horizontal boreholes, slanted boreholes, multilateral boreholes, and other borehole types.

FIG. 2 is an illustration of a flow diagram of an example method 200 for determining the various operating zones. Method 200 can be performed on a computing system, for example, orchestration framework system 1000 of FIG. 10 or dynamic map controller 1100 of FIG. 11. The computing system can be a reservoir controller, a well site controller, a rig controller, a geo-steering system, a data center, a cloud environment, a server, a laptop, a mobile device, smartphone, PDA, or other computing system capable of receiving the input parameters, and capable of communicating with other computing systems. Method 200 represents an algorithm that can be encapsulated in software code or in hardware, for example, an application, code library, dynamic link library, module, function, RAM, ROM, and other software and hardware implementations. The software can be stored in a file, database, or other computing system storage mechanism, such as an edge computing system. Method 200 can be partially implemented in software and partially in hardware.

Method 200 can perform the steps for the described processes, for example, collecting input parameters from sensors located downhole, surface sensors, data stores, other computing systems, or recommendations from the digital advisors, where data can be retrieved and analyzing the data to compute one or more recommendations. For example, input parameters can be received from downhole sensors, such as RPM, WOB, subterranean formation parameters or characteristics, borehole geometric properties, and other borehole operation parameters. Input parameters can be received from drilling rig sensors, such as WOB or rig limits. Input parameters can be received from other sources, such as engineering models, surveys, geological data, generally available stratigraphic data, and other data sources. Method 200 provides a demonstration of some of the differing systems that can provide input parameters and a demonstration of some of the borehole operation parameters and impact parameters that are analyzed. In practice, the implementation can extend to various systems providing input parameters and to various borehole operation parameters (for example drilling parameters) now known or identified in the future, and various impact parameters.

Method 200 starts at a step 205 and proceeds to a step 210, a step 220, a step 230, or a step 240. Step 210, step 220, step 230, and step 240 can be performed in any order, serially, in parallel, overlapping, or various combinations thereof. In step 210, input parameters can be received that correspond to a particular application, process, system, or digital advisor, for example, an advisor that is concerned with hole cleaning and pressure management (e.g., data received from a borehole operation assembly). In some aspects, the input parameters can include composite recommendations from the one or more digital advisors. The recommendations (that will be input to the orchestration framework) produced from such an advisor or application can be targets, limits, or set points for flow rate, RPM, or a limit for a maximum ROP to help ensure optimal hole cleaning and wellbore stability while drilling. The input parameters can include the impact parameter (which can include one or more impact values for the drilling parameter), the softness parameter, the drilling parameter, the targets (recommendations), or other data for generating the impact or risk maps.

Proceeding from step 210 to a step 212, the input parameters are used to generate one or more impact or risk maps. Well construction digital advisors, processes, applications, or systems provide independent recommendations in terms of RPM, WOB, flow rate, ROP, without explicit maps. In some aspects, some applications, such as vibrations, can utilize empirical relationships between parameters of the system, for example, the BHA design and the drilling parameters. In some aspects, the impact or risk maps can be built from historical data, simulated data, or lab generated data. The primary output for each individual application is an impact or risk map relating to the area of the recommended borehole operation parameters for that application. The one or more impact or risk maps can be stored as data or can be used to generate a graph, such as a graph 300 of FIG. 3A or graph 400 of FIG. 4. Proceeding from step 212, method 200 proceeds to a step 250 where the impact or risk maps generated in step 212 can be utilized to generate an integrated impact or risk map for the given borehole operation parameters.

In step 220, method 200 follows a similar process as shown in step 210 where input parameters can be received that correspond to a particular application, process, system, or digital advisor, for example a system that is concerned with vibration (e.g., data received from a borehole operation assembly). The recommendation produced by such a system can be syntactical, for example it can recommend whether to increase or decrease the current values of the borehole operation parameters depending on the type of vibration. The input parameters can include the impact parameter, softness parameter, the borehole operation parameter or recommendations, and other data for generating the impact or risk maps. Proceeding from step 220 to a step 222, the input parameters are used to generate one or more impact or risk maps. The impact or risk maps can be stored as data or can be used to generate a graph, such as a graph 340 of FIG. 3B, graph 500 of FIG. 5A, or graph 520 of FIG. 5B. Proceeding from step 222, method 200 proceeds to step 250.

In step 230, method 200 follows a similar process as shown in step 210 and step 220 where input parameters can be received that correspond to a particular application, process, system, or digital advisor, for example, a system that is concerned with identifying a no-go zone or critical RPM (e.g., data received from a borehole operation assembly). The input parameters can include the impact parameter, the softness parameter, the borehole operation parameter or critical RPMs, and other data for generating the impact or risk maps. Proceeding from step 230 to a step 232, the input parameters are used to generate one or more impact or risk maps. The impact or risk maps can be stored as data or can be used to generate a graph, such as a graph 380 of FIG. 3C. Proceeding from step 232, method 200 proceeds to step 250.

In step 240, method 200 can follow a similar process where input parameters can be received from a different application, process, system, or digital advisor, up to N number where N can be any positive number. For example, there can be N number of digital advisors where each respective one can produce recommendations in real-time or near real-time during drilling or produce recommendations pre-job (e.g., data received from a borehole operation assembly).

Proceeding from step 212, step 222, step 232 or step 242, method 200 proceeds to step 250. In step 250, after step 212, step 222, step 232, and step 242 have completed, the impact or risk maps from each of the proceeding steps can be combined into an integrated impact or risk map. Various algorithms can be utilized to generate the integrated impact or risk map, such as a maximum algorithm, a minimum algorithm, a mean algorithm, a median algorithm, a weighted average algorithm, or other types of algorithms. For example, a maximum impact criterion can be used to integrate the impact or risk maps. In some aspects, the combination of impact or risk maps can be influenced or prioritized by the trust parameter generated for each digital advisor. For example, step 212 and step 222 can have been computed where the respective advisors have different trust parameters assigned to the model employed by each advisor. The step with the higher trust parameter can have a greater influence on the combined impact or risk map that is generated.

In a step 255, the integrated impact or risk map can be analyzed, along with the input parameters, to determine a safe operating zone, an intermediate operating zone, or a no-go zone, and one or more borehole operation recommendations for the drilling operations to achieve the safe operating zone.

In an optional step, the operating zone determinations can be represented visually, such as a contour area, to allow a user to analyze the one or more recommendations. In some aspects, the contour area can be represented in a two- or three-dimensional (2D or 3D) representation, such as a surface plot. The surface plot can be utilized to evaluate the one or more recommendations to ensure the recommendations selected can achieve the goals of the drilling operation. Method 200 ends at a step 295.

FIG. 3A is an illustration of a diagram of an example graph 300 demonstrating a maximum RPM impact map for a first drilling system or a digital advisor. Graph 300 is a visual representation of a 2D graph for demonstration purposes. In some aspects, the analysis can be generated using data within a computing system without a visual component. In some aspects, the analysis can utilize three or more dimensions of data. Graph 300 has an x-axis 305 representing the drilling parameter values. Graph 300 has a y-axis 306 representing the impact severity. Graph 300 demonstrates input parameters from a maximum ROP or hole cleaning system, such as targets for flow rate, RPM, and a limit for maximum ROP to help ensure optimal hole cleaning and wellbore stability while drilling.

Some of the input parameters are the impact parameter and softness parameter for the specific drilling parameter being analyzed. A key 308 demonstrates these parameters with a sample impact value and a sample softness value. A plot line 310 illustrates the course of impact severity, using the values shown in key 308 if the current drilling RPM is below or above the maximum RPM recommended by the maximum ROP system or digital advisor.

FIG. 3B is an illustration of a diagram of an example graph 340 demonstrating a recommended RPM impact map. Graph 340 is a visual representation of a 2D graph for demonstration purposes. In some aspects, the analysis can be generated using data within a computing system without a visual component. In some aspects, the analysis can utilize three or more dimensions of data. Graph 340 has an x-axis 345 representing the drilling parameter values. Graph 340 has a y-axis 346 representing the impact severity. Graph 340 demonstrates input parameters from a second system.

Some of the input parameters are the impact parameter and softness parameter for the specific drilling parameter being analyzed. A key 348 demonstrates these parameters with two sample impact values and two sample softness values. A plot line 350 illustrates the course of impact severity, using the values shown in key 348 if the current drilling RPM is below or above the maximum RPM recommended by the second system.

FIG. 3C is an illustration of a diagram of an example graph 380 demonstrating a minimum RPM impact map. Graph 380 is a visual representation of a 2D graph for demonstration purposes. In some aspects, the analysis can be generated using data within a computing system without a visual component. In some aspects, the analysis can utilize three or more dimensions of data. Graph 380 has an x-axis 385 representing the drilling parameter values. Graph 380 has a y-axis 386 representing the impact severity. Graph 380 demonstrates input parameters from a third system, such as a critical RPM system.

Some of the input parameters are the impact parameter and softness parameter for the specific drilling parameter being analyzed. A key 388 demonstrates these parameters with a sample impact value and a sample softness value. A plot line 390 illustrates the course of impact severity, using the values shown in key 388 if the current drilling RPM is below or above the maximum RPM recommended by the third system.

FIGS. 3A, 3B, and 3C demonstrate the use of the impact parameter and the softness parameter (e.g., the safety factor). The impact parameter can indicate the impact severity associated with a particular event, such as if the data plot exceeds the impact value along the y-axis, then the specified drilling parameters are not in the safe operating zone. In some aspects, the softness parameter can indicate how hard or soft the limit (impact value) can be, e.g., it can indicate how large the acceptable range of impact values can be, such as plus or minus the percentage represented by the softness value added to the impact value. In some aspects, the softness parameter can be the impact build up or transition mechanism. The risk itself can be a combination of impact and probability parameter. For example, the analysis can determine whether the impact of having a hole cleaning issue or the drilling operations exceeding a mechanical limitation increases abruptly or gradually, when the current drilling RPM is greater than the maximum RPM recommended by the maximum ROP system. Graph 300 demonstrates that the impact severity increases gradually as the current drilling RPM exceeds the maximum RPM (where the maximum RPM is 200 for this example). Graph 340 demonstrates a steep increase in the impact severity.

Each of these impact maps can be computed in real-time or near real-time. In some aspects, the impact maps can be updated at a time interval, at a user request, or when the input parameters for that impact map have been updated or changed. A single system can have more than one recommendation. For example, the maximum ROP system can recommend an RPM for achieving the target maximum ROP, and it can recommend a minimum and a maximum RPM from a hole cleaning and pressure management standpoint. These recommendations can be interpreted as three sub-components of the maximum ROP system, where each have an impact map. In some aspects, the trust parameter can be applied to the advisors generating the minimum, maximum, and target RPMs. These values can be shifted using the trust parameter of each underlying model to favor the RPM with the higher trust parameter. For example, the target RPM range can be shifted toward either the minimum RPM or maximum RPM value, whichever value has the higher trust parameter. This can target the RPM towards more certainty and away from uncertainty ranges. In another example, the second system can provide recommendations for RPM and WOB to mitigate observed vibrations. There can be four sub-components, for example one associated with stick-slip and the others related to bit bounce, whirl, and lateral shock.

FIG. 4A is an illustration of a diagram of an example graph 400 demonstrating a medium level stick-slip vibration impact map. Graph 400 is a visual representation of a 2D graph for demonstration purposes. In some aspects, the analysis can be generated using data within a computing system without a visual component. In some aspects, the analysis can utilize three or more dimensions of data. Graph 400 has an x-axis 405 showing the WOB. Graph 400 has a y-axis 406 showing the surface RPMs. A key 410 shows a relative impact severity level where the dark bands on the top of key 410 are most severe, and the patterned bands of key 410 represent the lowest impact severity.

For frequency of occurrence and duration conditions, vibration can be analyzed for an example of the how to apply the disclosed processes. During drilling, vibration levels can be monitored and maintained below the specified limit of the tools being used. It can be accepted that tools can be briefly exposed to high levels of vibration before the vibration is controlled and hopefully eliminated. Damage can result when these high levels of vibration are sustained. The specified limit can be defined by reference to the measured severity of the vibration and either its duration or number of events; the tool can be deemed to have exceeded specified limits when one of the criteria is exceeded. For example, a medium level stick-slip can have a long-term impact, such as fatigue, on the system. If the stick-slip parameters show greater than a certain duration or number of occurrences, then the tool can be deemed to have exceeded the specified limits. Graph 400 illustrates a medium level stick-slip vibration impact map, where the warning area 415 shows a potential severity, when the duration or the number of occurrences is within the specified limit.

FIG. 4B is an illustration of a diagram of an example graph 430 demonstrating a medium level stick-slip vibration impact map when a duration threshold has been exceeded. Graph 430 is a visual representation of a 2D graph for demonstration purposes. In some aspects, the analysis can be generated using data within a computing system without a visual component. In some aspects, the analysis can utilize three or more dimensions of data. Graph 430 has an x-axis 435 showing the WOB. Graph 430 has a y-axis 436 showing the surface RPMs. A key 440 shows a relative impact severity level where the dark bands on the top of key 440 are most severe, and the patterned bands of key 440 represent the lowest impact severity.

Graph 430 shows the same scenario as graph 400 except that the medium level stick-slip vibration impact map demonstrates when one of the criteria has exceeded a limit, which has a higher impact on the system, as shown by severe area 445.

FIG. 5A is an illustration of a diagram of an example graph 500 demonstrating a buckling impact map with the WOB threshold set to 22.0 kilo pounds (klb) for sinusoidal and 28 klb for helical. The impact, softness, and WOB threshold limits can change as a function of depth, e.g., using a depth-based road map. Graph 500 is a visual representation of a 2D graph for demonstration purposes. In some aspects, the analysis can be generated using data within a computing system without a visual component. In some aspects, the analysis can utilize three or more dimensions of data. Graph 500 has an x-axis 505 showing the WOB. Graph 500 has a y-axis 506 showing the surface RPMs. A key 510 shows a relative impact severity level where the dark bands on the top of key 510 are most severe, and the patterned bands of key 510 represent the lowest impact severity.

Graph 500 shows an example of a learning-based mechanism. When a road map-based input is utilized, a possible significant instance of using dynamic impact maps can be when a recommendation or a limit, and impact and softness values, can be received from the road map. It can be a depth-based road map or a time-based roadmap. The values in the road map can be an output from a machine-learning algorithm, a register, or road map developed from offset-well analysis or lessons learned from previous experience, at the current well, a proximate well, other well systems, or various combinations thereof.

For example, a vibration advisor can have a depth-based impact and softness values (e.g., received from previous learnings) for different vibration mechanisms. Depending on the measured depth, the appropriate impact and softness values can be utilized as per the road map. Another instance of road map based dynamic impact maps can be a depth based WOB road map developed using data from offset wells and used to avoid autodriller control dysfunction thereby reducing stick-slip and delivering a maximum ROP. Graph 500 demonstrates buckling limits, where the WOB limits, impact, and softness values are updated using depth-based criteria, which in turn generates impact maps using that revised criteria. Depending on the measured depth the impact maps can be dynamically constructed using the WOB limit specified in the road map. The appropriate safe operating zone can be computed. Graph 500 demonstrates the impact map generated for a depth of 3,659 feet, and the determined safe operating zone 515.

FIG. 5B is an illustration of a diagram of an example graph 520 demonstrating a buckling impact map with the WOB threshold set to 36.7 klb for sinusoidal and 39.2 klb for helical. Graph 520 is a visual representation of a 2D graph for demonstration purposes. In some aspects, the analysis can be generated using data within a computing system without a visual component. In some aspects, the analysis can utilize three or more dimensions of data. Graph 520 has an x-axis 525 showing the WOB. Graph 520 has a y-axis 526 showing the surface RPMs and a key 530.

Graph 520 is similar to graph 500, with the impact and softness values modified due to the change in depth to 3,800 feet. Graph 520 demonstrates the impact map generated for this depth, and the determined safe operating zone 535, showing a change from safe operating zone 515.

FIG. 6A is an illustration of a diagram of an example graph 600 demonstrating an integrated impact map for RPM integrating the impact maps shown in FIGS. 3A, 3B, and 3C. Finding the maximum impact (at each drilling parameter value) was the algorithm used in FIG. 6A to integrate the impact maps. Graph 600 is a visual representation of a 2D graph for demonstration purposes. In some aspects, the analysis can be generated using data within a computing system without a visual component. In some aspects, the analysis can utilize three or more dimensions of data. Graph 600 has an x-axis 605 representing the drilling parameter values. Graph 600 has a y-axis 606 representing the impact severity. Graph 600 demonstrates input from the impact maps related to RPM computed previously. A plot line 610 illustrates the course of maximum impact severity when combining the corresponding impact maps.

FIG. 6B is an illustration of a diagram of an example graph 640 demonstrating an integrated impact map for WOB. Graph 640 is a visual representation of a 2D graph for demonstration purposes. In some aspects, the analysis can be generated using data within a computing system without a visual component. In some aspects, the analysis can utilize three or more dimensions of data. Graph 640 has an x-axis 645 representing the drilling parameter values. Graph 640 has a y-axis 646 representing the impact severity. Graph 640 demonstrates input from the impact maps related to RPM computed previously. A plot line 650 illustrates the course of maximum impact severity when combining the corresponding impact maps.

FIGS. 6A and 6B demonstrate the next step in the orchestration framework to combine the individual impact maps by a scalable logic. The disclosed processes perform this step by computing the maximum impact map using associated impact maps. In some aspects, impact maps can be first discretized, e.g., sampled, and then the impact severity values at the discrete points can be stored as vectors. This is demonstrated as the data points along plot line 610 and plot line 650. Next, the maximum value for each discrete point can be found among the identified vectors. The length of the vectors should be the same. Once the maximum impact severity values are found, the maximum impact map can be plotted as shown in FIG. 6A for RPM and FIG. 6B for WOB.

For example, the impact maps can be updated utilizing a prejob recommendation and a real-time or near real-time recommendation, wherein the updating utilizes an impact weighting for each impact severity, where the impact severity corresponds to a drilling parameter. The discretizing of each impact map in the one or more impact maps can be performed to determine a set of discrete points. A vector in a set of vectors can be stored, where each vector represents each impact severity value at each discrete point in the set of discrete points. A combinate value for each set of vectors for each discrete point in the set of discrete points can be calculated. Next, the integrated impact map can be computed utilizing the combinate value for each set of vectors. The integrated impact map can be utilized to determine the safe operating zone, the go zone, the no-go zone, or the intermediate zone. The borehole operation recommendations can be determined from the integrated impact map and the zone determinations.

FIG. 7A is an illustration of a diagram of an example graph 700 demonstrating an integrated impact map combining the impact maps of drilling parameters. Graph 700 is a visual representation of a 2D graph for demonstration purposes. In some aspects, the analysis can be generated using data within a computing system without a visual component. In some aspects, the analysis can utilize three or more dimensions of data. Graph 700 has an x-axis 705 showing the drilling parameters for WOB. Graph 700 has a y-axis 706 showing the surface RPMs. A key 710 shows a relative impact severity level where the dark bands on the top of key 710 are most severe, and the patterned bands of key 710 represent the lowest impact severity. Band 712 is the lowest impact severity level.

Band 712 is shown in graph 700 as a plot area 720. Plot area 720 represents the lowest impact severity level and therefore the highest recommendation to be communicated. For example, the recommendation could state having an RPM between 160 and 180, and a WOB between 0 and 14.

FIG. 7B is an illustration of a diagram of an example graph 750 demonstrating a simplified integrated impact map. Graph 750 is a simplification of graph 700, where the granularity of the impact is captured by three zones: a safe zone, an intermediate zone, and a no-go zone. Plot area 760 represents the safe zone. Plot area 765 represents the highest impact severity level and therefore the no-go zone. Plot area 770 represents the region intervening the safe zone and the no-go zone, it is the intermediate zone. This zone is as significant recommendation as safe zone or no-go zone because having this information will assist the user to decide whether the limits or boundaries can be pushed further with the respect to the impact on the system.

FIG. 8 is an illustration of a diagram of an example graph demonstrating a three-dimensional surface plot for the integrated impact map, for example, a type of combined impact map. Graph 800 is a visual representation of a 2D graph for demonstration purposes. In some aspects, the analysis can be generated using data within a computing system without a visual component. In some aspects, the analysis can utilize three or more dimensions of data. Graph 800 has an x-axis 805 showing the drilling parameters for WOB. Graph 800 has a y-axis 806 showing the RPMs of the drill bit. Graph 800 has a z-axis 807 showing the relative impact severities. A key 810 shows a relative impact severity where the light bands on the top of key 810 are most severe, and the dark bands of key 810 represent the lowest impact severity. A section 812 is shown in graph 800 and represents the lowest impact severity and therefore the drilling parameters associated with section 812 can be the highest recommendation to be communicated.

FIGS. 4A, 4B, 4C, 4D, 5A, 5B, 7A, 7B, and 8 demonstrate the generation of a contour plot or a three-dimensional surface plot. The contour plot or the three-dimensional surface plot can then be used to extract the safe operating zone for the borehole operation parameters where the impact severity level is low or acceptable. In some aspects, they can also be used to extract the intermediate and no-go zones.

FIGS. 3A, 3B, 3C, 4A, 4B, 4C, 4D, 5A, 5B, 6A, 6B, 7A, 7B, and 8 demonstrate the disclosed processes using a visual 2D or three-dimensional graph, e.g., visually representing the algorithms. A visual component is not needed for the processes and is used herein to explain the processes. The processes can be performed within a computing system using the input parameters.

FIG. 9 is an illustration of a block diagram of an example flow 900 demonstrating a process flow as described herein. Flow 900 demonstrates a functional view of method 200 and the other described processes, e.g., an overview of the implementation of the orchestration framework. Flow 900 can be implemented, for example, by orchestration framework system 1000 or dynamic map controller 1100.

In a flow block 910, various input parameters can be received. In some aspects, well construction parameters can be received, for example, limits, targets, set-points, recommendations (increase/decrease the parameter), go zones, no-go zones, real-time or near real-time data from sensors located downhole, survey parameters, geological parameters, surface sensors (e.g., rig sensors), equipment sensors, and other parameter sources. The various parameters can be received from one or more systems, IBUs, applications, digital advisors, or companies. The input parameters can be received as a prejob parameter and updated as the real-time or near real-time parameters are received.

In a flow block 920, preprocessing can be performed. Preprocessing can analyze the input parameters to ensure consistent scaling and representation. The input recommendations to the orchestration framework can be in various forms. They can be go zones, no-go zones, limits, syntactic recommendations (increase/decrease), or targets. The algorithm for computing the safe operating zone can interpret these input recommendations in a correct way. In some aspects, a preprocessing step can put these recommendations in an object-oriented semantic representation to improve the efficiency of the applied algorithms. Preprocessing can attribute the impact parameter, e.g., risk parameter, and the softness parameter. The impact parameter and softness parameter can be defaulted or can be specified as part of the input parameters. In some aspects, the trust parameter can be applied to effectively weight each advisor's recommendation as to the probability of the underlying model used by the advisor is accurate.

In a flow block 930, the safe operating zone, intermediate, or no-go zones can be determined. To determine these zones, each of the input parameters can be analyzed using an impact or risk map, for example, an individual impact or risk map for each well construction parameter. One or more of the impact or risk maps can be combined to compute an integrated impact or risk map (e.g., an integrated dynamic impact map). The impact or risk maps cane be combined using the trust parameter computed for the underlying advisor model. This can provide a prioritization or a weighting factor for when the maps are combined. The integrated impact or risk map can be utilized to determine the safe operating zone, no-go zone, or intermediate zone. Recommendations can be determined that can be communicated to a user, a user system, a well site controller, a rig controller, a drilling system, a borehole assembly, or other well construction system, where the recommendations can be used to direct operations to keep the well construction operations in the safe operating zone or to direct operations towards the safe operating zone or to direct operations away from the no-go zone. The integrated impact or risk maps can be represented by a contour map or a surface plot map.

In a flow block 940, a check can be made whether the output from flow block 930 exceeds one or more alert thresholds. For example, the analysis can determine that the well construction parameters are currently outside of the safe operating zone or within the no-go zone, or that there are no recommendations that are within the impact severity limits. An alert management system can receive the alert threshold information from flow block 930 and communicate the alert to a user, a user system, a well site controller, a rig controller, a reservoir controller, a drilling system, a borehole assembly, or other systems for further action. Alert thresholds can be specified for different systems, IBUs, digital advisors, applications, or company sources of input parameters. For example, if there is a vibration whose severity is critical, or if there is a hole cleaning issue, an alert can be sent out. For one or more systems utilizing an analysis of their individual impact or risk maps an alert can be triggered and sent to the user.

In a block flow 950, the recommendations in the form of safe zone, intermediate or no-go zones, the combined impact or risk maps, or other outputs can be communicated to one or more other systems. For example, the combined impact or risk maps can be displayed for a user along with a ranking of the recommendations utilizing the overall impact severity, e.g., the ranking of different digital advisors, systems, or applications accounting for the highest to lowest impact on the well construction system.

FIG. 10 is an illustration of a block diagram of an example orchestration framework system 1000, which can be implemented in one or more computing systems, for example, a data center, cloud environment, server, laptop, smartphone, tablet, and other computing systems. In some aspects, orchestration framework system 1000 can be implemented using an orchestration framework controller such as dynamic map controller 1100 of FIG. 11. Orchestration framework system 1000 can implement one or more methods of this disclosure, such as method 200 of FIG. 2.

Orchestration framework system 1000, or a portion thereof, can be implemented as an application, a code library, a dynamic link library, a function, a module, other software implementation, or combinations thereof. In some aspects, orchestration framework system 1000 can be implemented in hardware, such as a ROM, a graphics processing unit, or other hardware implementation. In some aspects, orchestration framework system 1000 can be implemented partially as a software application and partially as a hardware implementation. Orchestration framework system 1000 shows components that perform functions of the disclosed processes, and an implementation can combine or separate at least some of the described functions in one or more software or hardware systems.

Orchestration framework system 1000 includes a data transceiver 1010, a dynamic map analyzer 1020, and a result transceiver 1030. Data transceiver 1010, dynamic map analyzer 1020, and result transceiver 1030 can be, or can include, conventional interfaces configured for transmitting and receiving data. Data transceiver 1010 can receive input parameters, such as parameters to direct the operation of the analysis implemented by dynamic map analyzer 1020, such as identifying which algorithms to utilize and specifying operational parameters. In some aspects, data transceiver 1010 can be part of dynamic map analyzer 1020.

Dynamic map analyzer 1020 can be an impact and risk map processor and can implement the analysis and algorithms as described herein utilizing the input parameters. For example, dynamic map analyzer 1020 can perform the analysis of the input parameters, compute impact or risk maps and integrated impact or risk maps, compute a weighting or prioritization factor for each impact or risk map using trust parameters, generate one or more recommendations, and communicate the results to other systems, such as a reservoir planning system, a drilling planning system, a geo-steering system, a well site controller, a rig controller, a borehole assembly, or other well site systems. In some aspects, dynamic map analyzer 1020 can be a machine learning system, such as providing a process to analyze the collected input parameters from downhole sensors to provide a quality check on the data and to fill in potential gaps in the data.

A memory or data storage of dynamic map analyzer 1020 can be configured to store the processes and algorithms for directing the operation of dynamic map analyzer 1020. Dynamic map analyzer 1020 can also include one or more processors that is configured to operate according to the analysis operations and algorithms disclosed herein, and an interface to communicate (transmit and receive) data.

Result transceiver 1030 can communicate one or more results, analysis, or interim outputs, to one or more data receivers, such as a user or user system 1060, a computing system 1062, a borehole system 1064, a geo-steering system 1066, or other systems 1068 for processing or storing the recommendations, e.g., using a data store or database, whether located proximate result transceiver 1030 or distant from result transceiver 1030. The results, e.g., a determination of the recommendations, contour graphs, surface plots, interim outputs from dynamic map analyzer 1020, and other outputs, can be communicated to one or more of the data receivers for processing or storing data. The results can be used, for example, as inputs into a reservoir operation plan, a drilling plan, to determine the directions provided to a geo-steering system or used as inputs into a well site controller or other borehole system, such as a well site operation planning system. The results can be used to alter or execute a plan or operation, such as changing drilling locations for a reservoir, changing operational parameters or components for drilling (such as drill bit, drilling fluid, ROP, WOB, etc.), or changing direction of a steering a drill bit via a geo-steering system.

FIG. 11 is an illustration of a block diagram of an example of dynamic map controller 1100 according to the principles of the disclosure. Dynamic map controller 1100 can be stored on a single computer or on multiple computers. The various components of dynamic map controller 1100 can communicate via wireless or wired conventional connections. A portion or a whole of dynamic map controller 1100 can be located at one or more locations, such as a data center, a reservoir controller, an edge computing system, a cloud environment, a server, a laptop, a smartphone, or other locations. In some aspects, dynamic map controller 1100 can be wholly located at a downhole, a surface, or distant location. In some aspects, dynamic map controller 1100 can be part of another system, and can be integrated in a single device, such as a part of a reservoir operation planning system, a well site controller, a rig controller, a borehole assembly, a geo-steering system, or other borehole system.

Dynamic map controller 1100 can be configured to perform the various processes disclosed herein including receiving input parameters and generating recommendations from an execution of the methods and processes described herein. Dynamic map controller 1100 includes a communications interface 1110, one or more memory or data storages represented by memory 1120, and one or more processors represented by processor 1130.

Communications interface 1110 is configured to transmit and receive data. For example, communications interface 1110 can receive the input parameters, downhole sensor parameters, and other data. Communications interface 1110 can transmit the determined recommendations, data from the input parameters, contour graphs, surface plots, or interim outputs. In some aspects, communications interface 1110 can transmit a status, such as a success or failure indicator of dynamic map controller 1100 regarding receiving the various inputs, transmitting the determined recommendations, or producing the determined recommendations.

In some aspects, communications interface 1110 can receive input parameters from a machine learning system, for example, where the downhole sensor parameters are processed using one or more filters and algorithms prior to computing the impact or risk maps.

In some aspects, the machine learning system can be implemented by processor 1130 and perform the operations as described by dynamic map analyzer 1020. Communications interface 1110 can communicate via communication systems used in the industry. For example, wireless or wired protocols can be used. Communication interface 1110 is capable of performing the operations as described for data transceiver 1010 and result transceiver 1030 of FIG. 10.

Memory 1120 can be configured to store a series of operating instructions that direct the operation of processor 1130 when initiated, including the code representing the algorithms used for processing the collected data. Memory 1120 is a non-transitory computer readable medium. Multiple types of memory can be used for data storage and memory 1120 can be distributed.

Processor 1130, e.g., an impact or risk map processor or a maximum impact processor, can be configured to produce the generated results, e.g., the one or more recommendations, impact or risk map contours, surface plots, one or more interim outputs, and statuses utilizing the received inputs. Processor 1130 can be configured to direct the operation of dynamic map controller 1100. Processor 1130 includes the logic to communicate with communications interface 1110 and memory 1120, and perform the functions described herein, such as functions according to method 200. Processor 1130 can perform or direct the operations as described by dynamic map analyzer 1020 of FIG. 10.

FIG. 12 is an illustration of a diagram of an example chart 1200 showing the impact to an advisor using a trust model. Chart 1200 is similar to FIGS. 3A, 3B, and 3C while demonstrating additional details. Chart 1200 has an x-axis 1205 representing the borehole operation input parameters and a y-axis 1206 representing the impact the borehole operation has. Lines 1210 show the range of possible safety zone limits for the borehole operation. A softness parameter 1207 shows the range for which the borehole operation can operate between V₀ and V, where V is the recommended parameter for the borehole operation.

Chart 1200 demonstrates 3 properties that can be used by a digital advisor, the impact parameter (e.g., consequences on the borehole operation if the advisor recommendation is violated), the softness parameter (e.g., the impact build up or a transition mechanism), and the initial advisor recommendation (shown by a line 1220). The initial advisor recommendation can be deterministic or probabilistic. The recommendation can be probabilistic due to the uncertainty around parameters such as the borehole diameter, pad force, cutting concentration, or other factors. A probabilistic model can have a probability density function for the borehole operation (such as shown in FIGS. 13A and 13B). In some aspects, the probabilistic model can be computed by performing a design of experiment with the assumption that the recommendation of the advisor is correct (such as a Monte Carlo simulation).

Other properties that can be used by the digital advisor are a dynamic impact map and a trust model. The dynamic impact map can show the consequences or impact on the borehole operation when the consequences or impact do not remain constant. Factors can influence changes in the consequences or impact, such as a cumulative duration, frequency of occurrences, contexts, or other factors. The trust model can address the uncertainty of how accurate the model of an advisor is when computing the recommendation. In some aspects, a context-based relevance model can be defined to address the trust model.

FIG. 13A is an illustration of a diagram of an example chart 1300 showing the probability curve before applying a trust model. A probability curve 1310 shows the probability of accuracy of the advisor recommendation (“V”) for the borehole operation. The advisor recommendation can be represented in the form of a probability density function because of the uncertainty in the parameters, for example, hole diameter, pad force, cuttings concentration, or other uncertainties. Assuming the advisor model is correct, “V” can represent the absolute probability, meaning most likely, “V” is the correct recommendation for the borehole operation. A second source of uncertainty about the probability of whether the model is accurate can be described as conditional probability, as shown in FIG. 13B.

FIG. 13B is an illustration of a diagram of an example chart 1350 showing the probability curve after applying a trust model. Chart 1350 demonstrates a conditional probability curve 1360 that is more spread out than probability curve 1310. The transition from probability curve 1310 to conditional probability curve 1360 can be computed by multiplying the trust parameter with the probability density function. This transition from the absolute probability density function to the conditional probability density function can be due to the trust model that generates the trust parameter.

The modification to the advisor recommendation can be made to the dynamic impact map generation by performing a convolution operation, such as shown in Equation 1. The trust parameter can be a value in a range of 0.0 to 1.0, which can be represented as a probability of 0% to 100% that the advisor model can be trusted.
Equation 1: Example convolution operation to generate a dynamic risk map for a borehole operation

$$R = I * P$$

where R is the dynamic risk map,
I is the dynamic impact map,
P is the probability density function, and
T is the trust parameter, which can be multiplied with P or I to incorporate the trust model.

FIG. 14 is an illustration of a block diagram of an example trust model diagram 1400 with factors. Trust model diagram 1400 demonstrates some of the factors that can be considered when generating the trust parameter. Trust model diagram 1400 has a trust model 1410 that can generate the trust parameter, for example, a number within the range 0.0 and 1.0 inclusive. This trust parameter can be used in the advisor recommendation by multiplying the impact and probability by the trust parameter when computing the risk map for the borehole operation.

Trust model 1410 can use a multi-disciplinary design. Trust model 1410 can be an entity's subjective expectations of the behavior of other entities. At the same time, trust model 1410 can employ objective parameters such as stochasticity, measurability, context-dependent, and incomplete transitivity. The trust parameter can be computed for digital advisors by using two broad characteristics: a subjective part 1415 and an objective part 1420. Subjective part 1415 can be derived from one or more users' experience or opinion, and the business attributes. Subjective part 1415 can help quantify the accuracy of the advisor recommendation by using the subjective knowledge and observation 1430 about the advisor.

Objective part 1420 can be computed by monitoring the digital advisors and quantifying their accuracy using offset well analysis and by real-time or near real-time analysis under different contexts, or in other words, by computing a global part 1440, a local part 1442, and a hyperlocal part 1444 of the trust model. Global part 1440 can be the objective component of trust derived from all available wells whether located proximate the current borehole or located distant from the current borehole. Under global part 1440, trust can be computed at a macroscopic level, for example, tool failure because of excessive application of WOB or vibration. Local part 1442 can be the component that can be obtained from off-set well analysis. An example of local part 1442 can be kick and loss, which can occur while operating at high pressure and high temperature or while operating in wells containing trapped pressure.

Hyperlocal part 1444 can be computed by real-time or near real-time monitoring and analysis of the current borehole and by evaluating the consequences of critical events with global part 1440 under different contexts. Hyperlocal part 1444 can be a significant component to evaluate the trust since there can be black box applications where their respective recommendations assumes nothing bad happens until some failure happens. This scenario can be captured to avoid future incidents. Once the trust parameter is computed by using the above sub-components, it can be multiplied with the absolute probability density function (e.g., P in Equation 1) to obtain the conditional density function.

FIG. 15 is an illustration of a diagram of an example risk map calculation 1500 incorporating a trust model. Risk map calculation 1500 demonstrates how the risk map can be calculated from the impact map and the probability density function. The risk map can be computed by performing a convolution operation, as shown in Equation 1. Risk map calculation 1500 has an impact map (e.g., I) 1510 showing three parameter values (v, va, and vb) 1520, where v is the value (for any drilling parameter) recommended by the advisor, va and vb are the recommended values due to the shift operation in convolution and their corresponding probability values change accordingly as shown on the plot. These parameter values 1520 are plotted on impact map 1510 as line 1515.

Probability graph (e.g., P or the probability density function) 1530 shows the probability line 1535 for parameter values 1520. Applying Equation 1 (R=I*P) to impact map 1510 and probability graph 1530 can result in a risk map 1550. Parameter values 1520 have been replaced with a likely parameter value 1560 and a lower limit parameter 1562. Lower limit parameter 1562, with the R0 point on the y-axis indicate the allowable risk limits for the borehole operation. The total risk is indicated by risk line 1555. The trust model T, can be multiplied with the probability density function, e.g., probability graph 1530, or impact map 1510 to reflect the added adjustment for the trust model.

A portion of the above-described apparatus, systems or methods may be embodied in or performed by various analog or digital data processors, wherein the processors are programmed or store executable programs of sequences of software instructions to perform one or more of the steps of the methods. A processor may be, for example, a programmable logic device such as a programmable array logic (PAL), a generic array logic (GAL), a field programmable gate arrays (FPGA), or another type of computer processing device (CPD). The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Configured or configured to means, for example, designed, constructed, or programmed, with the necessary logic, circuitry, or features for performing a task or tasks. Examples of program code include both machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions, and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

Aspects disclosed herein include:
A. A method, including (1) receiving input parameters for a location within a borehole that include composite recommendations for a set of borehole operation parameters from more than one digital advisor, a respective impact parameter, a respective softness parameter for each recommendation of a borehole operation parameter in the set of borehole operation parameters, and a respective trust parameter for each digital advisor, (2) modifying dynamically the respective impact parameter, and the respective softness parameter using a supervision of one or more critical events or the more than one digital advisor, (3) generating a set of dynamic impact maps utilizing the input parameters, wherein each dynamic impact map in the set of dynamic impact maps is a correlation of an impact severity level or a risk severity level with the borehole operation parameter in the set of borehole operation parameters, and the correlation utilizes at least one impact value, at least one softness value, and at least one trust parameter for the borehole operation parameter, (4) computing an integrated dynamic impact map utilizing the set of dynamic impact maps and a determined integration algorithm, and (5) determining one or more borehole operation recommendations utilizing the integrated dynamic impact map, the set of dynamic impact maps and the input parameters, wherein the trust parameter specifies a value indicating an accuracy of a model used by the digital advisor.
B. A system, including (1) a data transceiver, capable of receiving input parameters for a location within a borehole, wherein the input parameters include one or more of composite recommendations for a set of borehole operation parameters from more than one digital advisor, a respective impact parameter, a respective softness parameter for each recommendation, and a trust parameter for a borehole operation parameter in the set of borehole operation parameters, and (2) an impact processor, capable of communicating with the data transceiver, dynamically modifying impact values, softness values, trust parameters, and associated limits using a supervision of one or more critical events or one or more digital advisors, and using learnings gathered from previous wells or an offset well analysis, generating one or more dynamic impact maps utilizing the input parameters, computing an integrated dynamic impact map utilizing the one or more dynamic impact maps, and determining one or more borehole operation recommendations utilizing the integrated dynamic impact map, the one or more dynamic impact maps, and the input parameters, wherein, the one or more dynamic impact maps is a correlation of an impact severity level and the borehole operation parameters, and the correlation utilizes at least one impact value, at least one softness value, and at least one trust parameter, the one or more borehole operation recommendations are used to modify a borehole operation plan of the borehole, and where the at least one trust parameter is computed from a trust model and specifies a value indicating an accuracy of a model used by the digital advisor.
C. A computer program product having a series of operating instructions stored on a non-transitory computer-readable medium that directs a data processing apparatus when executed thereby to perform operations to determine one or more borehole operation recommendations, the operations including (1) receiving input parameters for a location within a borehole that include composite recommendations for a set of borehole operation parameters from more than one digital advisor, a respective impact parameter, a respective softness parameter for each recommendation of a borehole operation parameter in the set of borehole operation parameters, and a respective trust parameter for each digital advisor, (2) modifying dynamically the respective impact parameter, and the respective softness parameter using a supervision of one or more critical events or the more than one digital advisor, (3) generating a set of dynamic impact maps utilizing the input parameters, wherein each dynamic impact map in the set of dynamic impact maps is a correlation of an impact severity level or a risk severity level with the borehole operation parameter in the set of borehole operation parameters, and the correlation utilizes at least one impact value, at least one softness value, and at least one trust parameter for the borehole operation parameter, (4) computing an integrated dynamic impact map utilizing the set of dynamic impact maps and a determined integration algorithm, and (5) determining one or more borehole operation recommendations utilizing the integrated dynamic impact map, the set of dynamic impact maps and the input parameters, wherein the trust parameter specifies a value indicating an accuracy of a model used by the digital advisor.

Each of the disclosed aspects in A, B, and C can have one or more of the following additional elements in combination. Element 1: executing a borehole operation using a well site controller or a rig controller for the borehole using the one or more borehole operation recommendations. Element 2: wherein the trust parameter is in an inclusive range of 0.0 to 1.0. Element 3: wherein each dynamic impact map in the set of dynamic impact maps is computed by multiplying the impact severity level or the risk severity level by a probability parameter of an event occurring and by the trust parameter. Element 4: wherein the one or more borehole operation recommendations further specify a specific target, a limit, or a relative direction of future borehole operations. Element 5: modifying a borehole operation of a borehole assembly through automatically applying the one or more borehole operation recommendations. Element 6: wherein the one or more borehole operation recommendations specify at least one of a safe operating zone, a set point, an intermediate zone, or a no-go zone. Element 7: wherein the borehole assembly is one or more of a drilling system or a well site system. Element 8: alerting a user or a borehole system when the one or more borehole operation recommendations determines an alert threshold is exceeded. Element 9: computing the trust parameter using a trust model, wherein the trust model utilizes at least one of one or more subjective factors or one or more objective factors. Element 10: wherein the one or more subjective factors include one or more of an opinion of one or more users, a survey result of one or more users, an experience of one or more users, or business needs. Element 11: wherein the one or more objective factors include one or more of a global part, a local part, or a hyperlocal part. Element 12: wherein the one or more objective factors utilize one or more of a stochasticity characteristic, a measurability characteristic, a context-dependent characteristic, or an incomplete transitivity characteristic. Element 13: wherein the trust model utilizes a global part that receives borehole operation data from one or more boreholes or one or more data stores. Element 14: wherein the trust model utilizes a hyperlocal part that receives real-time or near real-time data from sensors within the borehole, rig sensors at the borehole, or equipment sensors at the borehole. Element 15: an alert management system capable of generating an alert and communicating the alert to a user or a borehole system at a time when the at least one impact value, the at least one softness value, or the at least one trust parameter change according to a depth-based roadmap or a time-based roadmap. Element 16: a machine learning system, capable of communicating with the data transceiver and the impact processor, performing an analysis of the input parameters to generate the one or more dynamic impact maps, wherein the machine learning system outputs the at least one trust parameter using the analysis of the input parameters. Element 17: a result transceiver, capable of communicating the one or more borehole operation recommendations and interim outputs to a user system, a data store, or a computing system. Element 18: wherein the computing system is a drilling assembly, and the drilling assembly utilizes the one or more borehole operation recommendations to automatically adjust drilling operations at the borehole.

What is claimed is:

1. A method, comprising:
receiving input parameters for a location within a borehole that include composite recommendations for a set of borehole operation parameters from more than one digital advisor, a respective impact parameter, a respective softness parameter for each recommendation of a borehole operation parameter in the set of borehole operation parameters, and a respective trust parameter for each digital advisor;
modifying dynamically the respective impact parameter, and the respective softness parameter using a supervision of one or more critical events or the more than one digital advisor;
generating a set of dynamic impact maps utilizing the input parameters, wherein each dynamic impact map in the set of dynamic impact maps is a correlation of an impact severity level or a risk severity level with the borehole operation parameter in the set of borehole operation parameters, and the correlation utilizes at least one impact value, at least one softness value, and at least one trust parameter for the borehole operation parameter;
computing an integrated dynamic impact map utilizing the set of dynamic impact maps and a determined integration algorithm; and
determining one or more borehole operation recommendations utilizing the integrated dynamic impact map, the set of dynamic impact maps, and the input parameters, wherein the trust parameter specifies a value indicating an accuracy of a model used by the digital advisor.

2. The method as recited in claim 1, further comprising:
executing a borehole operation using a well site controller or a rig controller for the borehole using the one or more borehole operation recommendations.

3. The method as recited in claim 1, wherein the trust parameter is in an inclusive range of 0.0 to 1.0.

4. The method as recited in claim 1, wherein each dynamic impact map in the set of dynamic impact maps is computed by multiplying the impact severity level or the risk severity level by a probability parameter of an event occurring and by the trust parameter.

5. The method as recited in claim 1, wherein the one or more borehole operation recommendations further specify a specific target, a limit, or a relative direction of future borehole operations.

6. The method as recited in claim 1, furthering comprising:
modifying a borehole operation of a borehole assembly through automatically applying the one or more borehole operation recommendations.

7. The method as recited in claim 1, wherein the one or more borehole operation recommendations specify at least one of a safe operating zone, a set point, an intermediate zone, or a no-go zone.

8. The method as recited in claim 1, further comprising:
alerting a user or a borehole system when the one or more borehole operation recommendations determines an alert threshold is exceeded.

9. The method as recited in claim 1,
computing the trust parameter using a trust model, wherein the trust model utilizes at least one of one or more subjective factors or one or more objective factors.

10. The method as recited in claim 9, wherein the one or more subjective factors include one or more of an opinion of one or more users, a survey result of one or more users, an experience of one or more users, or business needs.

11. The method as recited in claim 9, wherein the one or more objective factors include one or more of a global part, a local part, or a hyperlocal part.

12. The method as recited in claim 9, wherein the one or more objective factors utilize one or more of a stochasticity characteristic, a measurability characteristic, a context-dependent characteristic, or an incomplete transitivity characteristic.

13. A system, comprising:
a data transceiver, capable of receiving input parameters for a location within a borehole, wherein the input parameters include one or more of composite recommendations for a set of borehole operation parameters from more than one digital advisor, a respective impact parameter, a respective softness parameter for each recommendation, and a trust parameter for a borehole operation parameter in the set of borehole operation parameters; and
an impact processor, capable of communicating with the data transceiver, dynamically modifying impact values, softness values, trust parameters, and associated limits using a supervision of one or more critical events or one or more digital advisors, and using learnings gathered from previous wells or an offset well analysis, generating one or more dynamic impact maps utilizing the input parameters, computing an integrated dynamic impact map utilizing the one or more dynamic impact maps, and determining one or more borehole operation recommendations utilizing the integrated dynamic impact map, the one or more dynamic impact maps, and the input parameters, wherein, the one or more dynamic impact maps is a correlation of an impact severity level and the borehole operation parameters, and the correlation utilizes at least one impact value, at least one softness value, and at least one trust parameter, the one or more borehole operation recommendations are used to modify a borehole operation plan of the borehole, and where the at least one trust parameter is computed from a trust model and specifies a value indicating an accuracy of a model used by the digital advisor.

14. The system as recited in claim 13, wherein the trust model utilizes a global part that receives borehole operation data from one or more boreholes or one or more data stores.

15. The system as recited in claim 13, wherein the trust model utilizes a hyperlocal part that receives real-time or near real-time data from sensors within the borehole, rig sensors at the borehole, or equipment sensors at the borehole.

16. The system as recited in claim 13, further comprising:
an alert management system capable of generating an alert and communicating the alert to a user or a borehole system at a time when the at least one impact value, the at least one softness value, or the at least one trust parameter change according to a depth-based roadmap or a time-based roadmap.

17. The system as recited in claim 13, further comprising:
a machine learning system, capable of communicating with the data transceiver and the impact processor, performing an analysis of the input parameters to generate the one or more dynamic impact maps, wherein the machine learning system outputs the at least one trust parameter using the analysis of the input parameters.

18. The system as recited in claim 13, further comprising:
a result transceiver, capable of communicating the one or more borehole operation recommendations and interim outputs to a user system, a data store, or a computing system.

19. The system as recited in claim 18, wherein the computing system is a drilling assembly, and the drilling assembly utilizes the one or more borehole operation recommendations to automatically adjust drilling operations at the borehole.

20. A computer program product having a series of operating instructions stored on a non-transitory computer-readable medium that directs a data processing apparatus when executed thereby to perform operations to determine one or more borehole operation recommendations, the operations comprising:
receiving input parameters for a location within a borehole that include composite recommendations for a set of borehole operation parameters from more than one digital advisor, a respective impact parameter, a respective softness parameter for each recommendation of a borehole operation parameter in the set of borehole operation parameters, and a respective trust parameter for each digital advisor;
modifying dynamically the respective impact parameter, and the respective softness parameter using a supervision of one or more critical events or the more than one digital advisor;
generating a set of dynamic impact maps utilizing the input parameters, wherein each dynamic impact map in the set of dynamic impact maps is a correlation of an impact severity level or a risk severity level with the borehole operation parameter in the set of borehole operation parameters, and the correlation utilizes at least one impact value, at least one softness value, and at least one trust parameter for the borehole operation parameter;
computing an integrated dynamic impact map utilizing the set of dynamic impact maps and a determined integration algorithm; and
determining one or more borehole operation recommendations utilizing the integrated dynamic impact map, the set of dynamic impact maps and the input parameters, wherein the trust parameter specifies a value indicating an accuracy of a model used by the digital advisor.
